(19) United States
(12) Patent Application Publication
(10) Pub. No.: US 2008/0199104 A1
(43) Pub. Date: Aug. 21, 2008

(54) METHOD AND APPARATUS FOR OBTAINING DRAWING POINT DATA, AND DRAWING METHOD AND APPARATUS

(75) Inventor: Mitsuru MUSHANO, Tokyo (JP)

Correspondence Address: YOUNG & THOMPSON, 209 Madison Street, Suite 500, ALEXANDRIA, VA, 22314, US

(73) Assignee: FUJIFILM CORPORATION, TOKYO (JP)

(21) Appl. No.: 11/861,516

(22) Filed: Sep. 26, 2007

(30) Foreign Application Priority Data
Sep. 29, 2006 (JP) 2006-269561

(51) Int. Cl. G06K 9/32

(52) U.S. Cl. 382/296

(57) ABSTRACT

The drawing point data obtaining method and apparatus subject original image data to transformation processing to obtain transformed image data as drawing point data used to draw an image carried by the original image data on a drawing target. The method and apparatus maintain in advance multiple sets of transformed image data obtained by performing transformation processing on the original image data under multiple different transformation processing conditions, choose, as temporary transformed image data, one set obtained under a condition close to an entered transformation processing condition and perform the transformation processing on the thus chosen temporary transformed image data in accordance with a differential between the entered condition and the condition for the chosen temporary transformed image data to thereby obtain the transformed image data as the drawing point data.

### BACKGROUND OF THE INVENTION

The present invention relates to a drawing point data obtaining method for performing transformation processing on original image data and obtaining transformed image data in the form of drawing point data which is used to draw the image carried by the original image data on a drawing target, and a drawing point data obtaining apparatus for practicing such a method; as well as to a drawing method for forming the image carried by the original image data on the drawing target based on the drawing point data obtained, and a drawing apparatus for practicing such a method.

Image transformation processing for obtaining transformed image data from original image data through image transformation such as rotation, enlargement, reduction, and arbitrary transformation is an essential part of image processing, and various methods of image transformation processing have been proposed.

One of the proposed image transformation processing methods can be found in JP 2001-285612 A. In the method, in order that the image (original image data) read or inputted into a copying machine, printer or other image recording apparatus may be outputted as the image (rotated image data) which is rotated, for instance, 90°, conditions for image rotation such as the image size and the direction and angle of rotation are previously set as required, to be more specific, so that the image may have a size of 32×32 bits and be rotated 90° counterclockwise, and so forth in the case where the image data is in binary form, individual pieces of pixel data are read out from the memory such as RAM in which the original image data is recorded, in an ordinary manner by 32 bits in the row (X) direction, for instance, then transferred to another image memory such as RAM in which a rotated image data is to be recorded, through discontinuous addressing so that they may be in a form rotated by a desired angle when read out in an ordinary manner, and written therein by 32 bits in the column (Y) direction as the rotated image data. In consequence, the individual pieces of pixel data of the rotated image data are in a form rotated 90° when read out in an ordinary manner (see FIGS. 8 and 9 and paragraphs [0040] to [0042] of JP 2001-285612 A).

With the above-mentioned method of JP 2001-285612 A, data transfer by 32 bits has to be executed 32 times and image data has to be transferred from discontinuous addresses in order to obtain a 32×32 bit rotated image, which prolongs image rotation processing. As a result, output processing takes a longer time than without image rotation. JP 2001-285612 A therefore suggests performing image rotation processing prior to actual output processing, preferably in a standby period where no other processing would be executed.

Another image transformation processing method that has been proposed is so-called direct mapping method. The method obtains transformed image data by converting the coordinate values of the individual pieces of pixel position information indicating the positions of individual pieces of pixel data of the transformed image data to be obtained into those in the coordinate system of original image data, in other words, putting the coordinate values through the inverse conversion for the transformation opposite to the desired one, obtaining the original pixel data in the original image data that corresponds to the inversely-convexted coordinate values, and treating the original pixel data thus obtained as the pixel data of the above pixel position information of the transformed image data.

For instance, to obtain transformed image data that is shown in FIG. 21B by rotating original image data shown in FIG. 21A clockwise through direct mapping, counterclockwise rotation computation is performed on pixel position information (x′, y′), which indicates where pixel data of the transformed image data to be obtained is located, to thereby obtain inversely-converted pixel position information (x, y), original pixel data is obtained that is located in the position indicated by the inversely converted pixel position information (x, y), and the obtained original pixel data is treated as the pixel data of the pixel position information (x′, y′). The transformed image data that is shown in FIG. 21B is thus obtained.

The direct mapping method as above, however, cannot escape a prolonged image transformation processing such as rotation either because the original pixel data in the position indicated by the inversely-converted pixel position information (x, y) needs to be read out, that is to say, reading of image data at discontinuous addresses is required, when the transformed image data is obtained from the original pixel data.

Meanwhile, various exposure systems utilizing photolithography have been proposed as an equipment for recording a given pattern such as a wiring pattern or a filter pattern on the substrate of a printed wiring board (PWB) or a flat panel display (FPD) such as a liquid crystal display (LCD) and a plasma display panel (PDP).

Such exposure systems use, for instance, a spatial light modulator such as digital micromirror device (DMD) to scan and irradiate a substrate to which photoresist has been applied with numerous beams of light modulated by the spatial light modulator in accordance with image data that represents a specified pattern. The specified pattern is thus formed on the substrate.

In an example of the exposure system that uses a DMD (see JP 2004-233718A), relative movement of the DMD in relation to the exposure surface of a substrate is allowed in a specified scanning direction and, in response to the movement in the scanning direction, frame data composed of many pieces of drawing point data which correspond to many micromirrors of the DMD is inputted into the memory cells of the DMD. Groups of drawing points corresponding to the micromirrors of the DMD are formed sequentially in time series to form a desired image on the exposure surface.

PWB wiring patterns and so forth formed by such exposure systems are increasingly becoming finer and more detailed and, to fabricate a multilayer printed wiring board, for instance, wiring patterns on the individual layers must be registered with high precision. Also, FPDs are more and more increasing in size, and filter patterns have to be registered with high precision regardless of their large sizes.

Exposure systems that use a DMD are dealing with finer patterns by slanting the DMD at a given angle and thus increasing the density of exposure dots. This makes it necessary to use, instead of the original image data as such, the rotated image data which is obtained by rotating the original image data by the angle of the slanting in order to create many pieces of drawing point data corresponding to many micromirrors of the DMD that are to be inputted into the memory cells of the DMD.

In that case, the direct mapping method as described above, for instance, is applicable.

### SUMMARY OF THE INVENTION

Direct mapping may take long if every piece of pixel position information of transformed image data is to be subjected to such an inverse conversion as described above, that is to say, inverse conversion computing processing has to be executed the same number of times as the number of pieces of pixel data of the transformed image data. The above-mentioned methods of image transformation processing will be even more time-consuming especially with the recent continuous increase in resolution of image data to be processed.

Further, in conventional image transformation processing methods which all require discontinuous addressing in transferring image data, image rotation and scaling take a longer time if the rotation angle and other transformation amounts are increased and, accordingly, addressing is more frequently made discontinuous, which means that the image processing time is increased almost in proportion to the increase in the rotation angle and other transformation amounts in a particular case of compressed image data, the image data has to be decompressed every time addressing is discontinuous as described above to, for example, edit the image data of different rows and compress the edited image data, leading to a further increased time for image transformation processing due to a more frequent editing needed.

A possible solution is to set previously the image size, the direction and angle of rotation, and other conditions for image rotation as required and perform image rotation prior to actual output processing as described in JP 2001-285612 A. However, in an exposure system that uses a DMD, while the tilt angle of the DMD can be set in advance, it is difficult to align a substrate accurately with the DMD, which substrate is to be exposed to light by the DMD of the exposure system and is placed on the stage moved relatively in relation to the DMD. Also, there are fluctuations in relative position during the movement, wobbling of the moving stage, deformation of the substrate itself if it receives heat treatment, and so forth, and it is impossible to take all those changes into consideration in advance. The method described in JP 2001-285612 A therefore cannot be applied to such a system.

As described above, it takes the conventional exposure systems that use a DMD a long time to perform rotation, scaling, and other types of image transformation processing, and their image processing capacity needs a costly improvement in order to avoid the problem.

For example, a substrate can be positioned accurately with respect to the DMD, at least with regard to the tilt angle, if a θ stage (rotary stage) is employed as the stage on which a substrate is placed, but the use of the G stage leads to an increase in cost of the exposure system.

To give another example, a dynamic support program (DSP) may be used to execute time-consuming image transformation processing such as rotation or scaling in real time, but the processing capacity of DSP has a certain limitation due to the line buffers which are limited in number.

The processing capacity (power) of a computer such as a personal computer or of the DSP may be enhanced, but such power enhancement raises the cost.

The present invention has been made in view of the above-mentioned problems, and a first object of the present invention is to provide a drawing point data obtaining method which allows rotation, scaling, and other types of image transformation processing, which require more image processing time as the angle of rotation, enlargement/reduction factor, and other transformation amounts are increased, to be carried out even with a lower image processing capacity, and which makes it possible at low costs and high tact to obtain drawing point data to be used for drawing from the original image data in order to draw the image carried by the original image data on a drawing target; and an apparatus for practicing such a method.

A second object of the present invention is to provide a drawing method which makes it possible at low costs and high tact to draw the image carried by the original image data on a drawing target based on the drawing point data that is obtained by the drawing point data obtaining method and apparatus capable of achieving the above first object; and an apparatus for practicing such a method.

Another object of the-present invention is to speed up image transformation processing such as rotation and scaling.

Still another object of the present invention is to form a desired image in a desired position on a substrate irrespective of deformation of the substrate, deviation in moving direction thereof, or the like.

To attain the first object, according to a first aspect of the present invention, there is provided a drawing point data obtaining method of subjecting original image data to transformation processing to obtain transformed image data as drawing point data which is used to draw an image carried by said original image data on a drawing target, comprising the steps of:

maintaining in advance multiple sets of transformed image data obtained by performing the transformation processing on the original image data through a first processing method under multiple different transformation processing conditions, respectively;

choosing, as temporary transformed image data, one set out of the multiple sets of transformed image data which has been obtained under a transformation processing condition close to an entered transformation processing condition in the multiple different transformation processing conditions; and

performing the transformation processing on the thus chosen temporary transformed image data through a second processing method in accordance with a differential between the entered transformation processing condition and the transformation processing condition for the chosen temporary transformed image data to thereby obtain the transformed image data as the drawing point data.

In a first mode of this aspect, when the chosen temporary transformed image data is input image data and the differential is a transformation processing condition of the transformation processing, the second processing method preferably comprises the steps of:

setting post-transformation vector information which connects pixel position information indicating arranging positions where pixel data of the transformed image data to be obtained is located;

obtaining part of the pixel position information on a post-transformation vector represented by the thus set post-transformation vector information;

subjecting only the thus obtained part of the pixel position information to an inverse conversion calculation being inverse transformation processing opposite to the transformation processing to obtain inversely-converted pixel position information on the input image data that corresponds to the part of the pixel position information;

obtaining, based on the inversely-converted pixel position information thus obtained, input pixel data corresponding to the post-transformation vector from the input image data; and

obtaining the input pixel data as pixel data in a position indicated by the pixel position information on the posts transformation vector, to thereby obtain the transformed image data.

It is preferable that the step of obtaining the input pixel data comprises the steps of:

setting input vector information on the input image data which connects the inversely-converted pixel position information; and

obtaining, from the input image data, the input pixel data on an input vector represented by the thus set input vector information,

and that the input pixel data is obtained as the pixel data in the position indicated by the pixel position information on the posttransformation vector and thereby, the transformed image data is obtained.

Preferably, the input vector information is set by connecting the inversely-converted pixel position information by a curve.

Preferably, the input vector information contains a pitch component for obtaining the input pixel data, or the pitch component for obtaining the input pixel data is set based on the input vector information.

When the original image data is the input image data and a transformation processing condition of the transformation processing is one of the multiple different transformation processing conditions, the first processing method preferably comprises the same steps as the second processing method.

In order to draw the image using a two-dimensional spatial modulator having multiple drawing point forming areas which are arrayed two-dimensionally, it is preferable that the drawing point data is mapped onto the multiple drawing point forming areas of the two-dimensional spatial modulator and created as frame data composed of an aggregation of drawing data which is used for drawing on the multiple drawing point forming areas.

In a second mode of this aspect, when the chosen temporary transformed image data is input image data, the differential is a transformation processing condition of the transformation processing, and the drawing target has undergone a transformation whose amount is equal to the differential, the second processing method preferably comprises the steps of:

moving relatively in relation to the drawing target drawing point forming areas in which drawing points are formed based on the drawing point data; as well as

forming the drawing points on the drawing target sequentially in response to movement of the drawing target and drawing point forming areas to obtain the drawing point data used for drawing an image carried by the input image data on the drawing target,

and, also preferably, the second processing method further comprises the steps of:

obtaining information about drawing point data tracks of the drawing point forming areas of the image on the input image data; and

obtaining multiple pieces of the drawing point data that correspond to the drawing point data tracks from the input image data based on the thus obtained information about the drawing point data tracks.

The step of obtaining the information about the drawing point data tracks preferably comprises the steps of:

obtaining information about drawing tracks of the drawing point forcing areas on the drawing target when the image carried by the input image data is formed; and

obtaining the information about the drawing point data tracks of the drawing point forming areas of the image on the input image data based on the thus obtained information about the drawing tracks.

Or again, the step of obtaining the information about the drawing point data tracks preferably comprises the steps of:

obtaining information about drawing tracks of the drawing point forming areas in an image space on the drawing target; and

obtaining the information about the drawing point data tracks of the drawing point forming areas of the image on the input image data based on the thus obtained information about the drawing tracks.

Preferably, multiple reference marks and/or reference parts provided in given positions on the drawing target are detected to obtain the detected position information which indicates the positions of the reference marks and/or reference parts, and drawing track information is obtained based on the detected position information thus obtained.

It is also preferable to obtain information about the deviation of the direction of relative movement and/or the attitude upon moving which the drawing target actually takes during drawing from a predetermined direction of relative movement and/or a predetermined attitude upon moving, and obtain the drawing track information based on the deviation information thus obtained.

It is also preferable that the deviation information is obtained which indicates the deviation of the direction of relative movement and/or the attitude upon moving which the drawing target actually takes during drawing from a predetermined direction of relative movement and/or a predetermined attitude upon moving, and the drawing track information is obtained based on the obtained deviation information and the detected position information.

Preferably, the number of pieces of drawing point data obtained from the individual pieces of pixel data that constitute the image data is changed in accordance with the length of a drawing track indicated by the drawing track information.

Preferably, speed fluctuation information is obtained which indicates fluctuations in the actual speed of relative movement which the drawing target has during drawing with respect to a predetermined speed of relative movement and, based on the obtained speed fluctuation information, the drawing point data is obtained from the individual pieces of pixel data that constitute the image data such that more pieces of drawing point data are obtained for the regions to be drawn of the drawing target whose actual speed of relative movement is lower.

Preferred is a drawing point data obtaining method for obtaining drawing point data used for drawing with multiple drawing point forming areas, in which the drawing point data is obtained for every drawing point forming area.

The drawing point forming areas are preferably beam spots provided by a spatial light modulator.

Preferably, the drawing point data track information is accompanied by a pitch component for obtaining the drawing point data.

With multiple drawing point forming areas being provided, it is preferable that one piece of drawing point data track information is obtained for every two or more drawing point forming areas.

The multiple drawing point forming areas are preferably arrayed two-dimensionally.

When the original image data is the input image data and a transformation amount in the transformation of the drawing target is one of multiple different transformation amounts in the transformation of the drawing target, the first processing method preferably comprises the same steps as the second processing method in the first mode of this aspect.

Alternatively: When the original image data is the input image data and a transformation amount in the transformation of the drawing target is one of multiple different transformation amounts in the transformation of the drawing target, the first processing method preferably comprises the same steps as the second processing method as described above.

In order to draw the image using a two-dimensional spatial modulator having multiple drawing point forming areas which are arrayed two-dimensionally, it is preferable that

the drawing point data is obtained for each of the multiple drawing point forming areas of the two-dimensional spatial modulator, the thus obtained multiple pieces of the drawing point data are arrayed two-dimensionally in accordance with the multiple drawing point forming areas, and

the multiple pieces of the drawing point data thus arrayed two-dimensionally are transposed and created as frame data composed of an aggregation of drawing data which is used for drawing with multiple drawing elements of the two-dimensional spatial modulator.

In this aspect, the original image data and the transformed image data are preferably compressed image data.

In addition, the original image data and the transformed image data are preferably binary image data.

To attain the second object, according to a second aspect of the present invention, there is provided a drawing method comprising the step of drawing an image carried by original image data on a drawing target based on drawing point data that is obtained by the drawing point data obtaining method according to the first aspect of the present invention.

To attain the first object, according to a third aspect of the present invention, there is provided a drawing point data obtaining apparatus for subjecting original image data to transformation processing to obtain transformed image data as drawing point data which is used to draw an image carried by the original image data on a drawing target, comprising:

a data maintaining section for maintaining in advance multiple sets of transformed image data obtained by performing the transformation processing on the original image data through a first processing method under multiple different transformation processing conditions, respectively;

an image selecting section for choosing, as temporary transformed image data, one set out of the multiple sets of transformed image data which has been obtained under a transformation processing condition close to an entered transformation processing condition in the multiple different transformation processing conditions; and

a transformation processing section for performing the transformation processing on the thus chosen temporary transformed image data through a second processing method in accordance with a differential between the entered transformation processing condition and the transformation processing condition for the chosen temporary transformed image data to thereby obtain the transformed image data as the drawing point data.

In a first mode of this aspect, it is preferable that, when the chosen temporary transformed image data is input image data and the differential is a transformation processing condition of the transformation processing, the transformation processing section executes the second processing method and comprises:

a post-transformation vector information setting section for setting post-transformation vector information which connects pixel position information indicating arranging positions where pixel data of said transformed image data to be obtained is located;

a pixel position information obtaining section for obtaining part of the pixel position information on a post-transformation vector represented by the post-transformation vector information set by the post-transformation vector setting section;

an inverse conversion calculating section for subjecting only the part of the pixel position information obtained by the pixel position information obtaining section to an inverse conversion calculation being inverse transformation processing opposite to the transformation processing to obtain inversely converted pixel position information in the input image data that corresponds to the part of the pixel position information;

an input pixel data obtaining section for obtaining, based on the inversely-converted pixel position information obtained by the inverse conversion calculating section, input pixel data corresponding to the post-transformation vector from the input image data; and

a transformed image data obtaining section for obtaining the input pixel data obtained by the input pixel data obtaining section as pixel data in a position indicated by the pixel position information on the post-transformation vector, to thereby obtain the transformed image data.

In this mode, it is preferable that the apparatus further comprises a frame data creating section, in order to draw the image using a two-dimensional spatial modulator having multiple drawing point forming areas which are arrayed two-dimensionally, for mapping the drawing point data onto the multiple drawing point forming areas of the two-dimensional spatial modulator and creating the thus mapped drawing point data as frame data composed of an aggregation of drawing data which is used for drawing on the multiple drawing point forming areas.

In this mode, it is preferable that the apparatus further includes an original vector information setting section for setting original vector information in original image data, which information connects the inversely-converted pixel position information, and an original pixel data obtaining section obtains original pixel data on an original vector represented by the original vector information set by the original vector information setting section from the original image data.

The original vector information setting section preferably sets the original vector information by connecting the inversely-converted pixel position information by a curve

Preferably, the original vector information is made to contain a pitch component for obtaining the original pixel data, or a pitch component for obtaining the original pixel data is set based on the original vector information.

In a second mode of this aspect, it is preferable that, when the chosen temporary transformed image data is input image data, the differential is a transformation processing condition of the transformation processing, and the drawing target has undergone a transformation whose amount is equal to the differential, the transformation processing section executes the second processing methods moves relatively in relation to the drawing target drawing point forming areas in which drawing points are formed based on the drawing point data as well as forms the drawing points on the drawing target sequentially in response to movement of the drawing target and drawing point forming areas to obtain the drawing point data used for drawing an image carried by the input image data on the drawing target, and comprises:

a drawing point data track information obtaining section for obtaining information about drawing point data tracks of the drawing point forming areas of the image on the input image data; and

a drawing point data obtaining section for obtaining multiple pieces of the drawing point data that correspond to the drawing point data tracks from the input image data based on the obtained information about the drawing point data tracks.

In this mode, it is preferable that the apparatus further comprises a frame data creating section, in order to draw the image using a two-dimensional spatial modulator having multiple drawing point forming areas which are arrayed two-dimensionally, for obtaining the drawing point data for each of the multiple drawing point forming areas of the two-dimensional spatial modulator, for arraying the thus obtained multiple pieces of the drawing point data two-dimensionally in accordance with the multiple drawing point forming areas, and transposing the multiple pieces of the drawing point data thus arrayed two-dimensionally to create as frame data composed of an aggregation of drawing data which is used for drawing with multiple drawing elements of the two-dimensional spatial modulator.

In this mode, it is preferable that the apparatus further includes a position information detecting section for detecting multiple reference marks and/or reference parts provided in given positions on the drawing target to obtain the detected position information which indicates the positions of the reference marks and/or reference parts, and a drawing track information obtaining section obtains drawing track information based on the detected position information obtained by the position information detecting section.

It is also preferable in this mode that the apparatus further includes a deviation information obtaining section for obtaining information about the deviation of the direction of relative movement and/or the attitude upon moving which the drawing target actually takes during drawing from a predetermined direction of relative movement and/or a predetermined attitude upon moving, and the drawing track information obtaining section obtains the drawing track information based on the deviation information obtained by the deviation information obtaining section.

In this mode, it is preferable that the apparatus further includes the deviation information obtaining section for obtaining information about the deviation of the direction of relative movement and/or the attitude upon moving which the drawing target actually takes during drawing from a predetermined direction of relative movement and/or a predetermined attitude upon moving, and the drawing track information obtaining section obtains the drawing track information based on the deviation information obtained by the deviation information obtaining section and the detected position information obtained by the position information detecting section.

Preferably, the drawing point data obtaining section changes the number of pieces of drawing point data obtained from each of the pieces of pixel data that constitute the image data in accordance with the length of a drawing track indicated by the drawing track information.

In this mode, it is preferable that the apparatus further includes a speed fluctuation information obtaining section for obtaining speed fluctuation information which indicates fluctuations in the actual speed of relative movement which the drawing target has during drawing with respect to a predetermined speed of relative movement, and the drawing point data obtaining section obtains, based on the speed fluctuation information obtained by the speed fluctuation information obtaining section, the drawing point data from the individual pieces of pixel data that constitute the image data such that more pieces of drawing point data are obtained from each piece of pixel data for the regions to be drawn of the drawing target having an actual speed of relative movement which is lower.

Preferably, multiple drawing point forming areas are provided, and the drawing point data obtaining section obtains the drawing point data for every drawing point forming area.

The drawing point data obtaining apparatus preferably includes a spatial light modulator which forms drawing point forming areas.

Preferably, the drawing point data track information is accompanied by a pitch component for obtaining the drawing point data.

It is preferable that multiple drawing point forming areas are provided, and the drawing point data track information obtaining section obtains one piece of drawing point data track information for every two or more drawing point forming areas.

The multiple drawing point forming areas are preferably arrayed two-dimensionally.

To attain the second object, according to a fourth aspect of the present invention, there is provided a drawing apparatus comprising;

a drawing point data obtaining apparatus according to the third aspect of the present invention; and

a drawing unit for drawing an image carried by the original image data on the drawing target based on the drawing point data obtained by the drawing point data obtaining apparatus.

The term “vector information” means not only vector information that connects the pixel posit-ion information or inversely-converted pixel position information by a straight line, but vector information that connects the pixel position information or inversely-converted pixel position information by a curve.

Examples of “inverse conversion calculation” include a calculation representing rotation in a direction opposite to a specified direction when the above-mentioned transformation is rotation in the specified direction, a calculation representing reduction when the above-mentioned transformation is enlargement, and a calculation representing a shift in a direction opposite to a specified direction when the above-mentioned transformation is a shift in the specified direction.

The multiple drawing point forming areas can be arrayed two-dimensionally. The “drawing point forming areas” can be provided by any measure as long as they form drawing points on a substrate, and examples thereof include beam spots made by the beams of light reflected by individual modulating elements of a spatial light modulator such as DMD, beam spots made by the beams of light from a light source in themselves, and areas for adhesion of the ink ejected from individual nozzles of an inkjet printer.

According to the drawing point data obtaining method and apparatus of the first and third aspects of the present invention, transformed images obtained by performing image transformation processing under fixed multiple conditions (angle of rotation, enlargement/reduction factor, and other transformation amounts) independent of actual processing conditions (angle of rotation, enlargement/reduction factor, and other transformation amounts) are maintained or kept in advance, one of the transformed images is chosen whose processing condition is close to the actual one, and the transformed image thus chosen is subjected to the image transformation processing in accordance with the differential between the actual processing condition and the processing condition for the relevant transformed image. In consequence, rotation, scaling, and other types of image transformation processing, which require more image processing time as the angle of rotation, enlargement/reduction factor, and other transformation amounts are increased, can be carried out even with a lower image processing capacity, and the drawing point data used for drawing can be obtained from the original image data at low costs and high tact in order to draw the image carried by the original image data on a drawing target.

According to the drawing method and apparatus of the second and fourth aspects of the present invention, the image carried by the original image data can be formed on a drawing target at low costs and high tact based on the drawing point data obtained by the drawing point data obtaining method and apparatus having the above-mentioned effects.

According to the first mode of the various aspects of the present invention, only part of pixel position information in transformed image data must experience an inverse conversion calculation in image transformation processing such as rotation and scaling, so that, in addition to the above-mentioned effects, there is an effect of speeding up the acquisition of transformed image data compared to the conventional case in which every piece of pixel position information experiences the inverse conversion calculation.

According to the second mode of the various aspects of the present invention, not only the above-mentioned effects are brought about but a desired image can be formed in a desired position on a substrate or other drawing target without being affected by the deformation of the drawing target, deviation in moving direction thereof, or the like. In this mode, multiple pieces of drawing point data, which correspond to the drawing point data tracks of drawing point forming areas in the image data representing an image, are obtained from the image data based on the information about drawing point data tracks, and the information about drawing point data tracks can be obtained based on the information which is obtained in advance on the drawing tracks of the drawing point forming areas that are made on the substrate or other drawing target or in an image space. Therefore, even if the drawing target such as a substrate has suffered deformation or deviation in position, for example an image adapted to the deformation or deviation in position can be formed on the drawing target. In fabricating a multilayer I printed wiring board, for example, this makes it possible to form wiring patterns on the respective layers in a manner that accommodates to the transformations of the layers and, accordingly, align the wiring patterns on the different layers with one another.

According to this mode, when, for example, a substrate serving as a drawing target is scanned with a beam of light by moving the substrate in a specified direction and a deviation in moving direction of the substrate occurs, information about the drawing tracks corresponding to the deviation in moving direction is obtained in advance and the drawing point data that corresponds to the drawing track information is obtained from the image data. Therefore, a desired image can be formed in a desired position on the substrate without being affected by the deviation in moving direction.

According to this mode, calculation of addresses in a memory storing image data, which is to be performed in order to obtain drawing point data, is feasible along the above-mentioned drawing point data tracks, which facilitates the address calculation. This mode is therefore particularly effective when the image data is compressed image data.

### BRIEF DESCRIPTION OF THE DRAWINGS

In the accompanying drawings:

FIG. 1 is a perspective view showing a schematic structure of an embodiment of an exposure system to which the drawing apparatus of the present invention for carrying out the drawing method of the present invention is applicable;

FIG. 2 is a perspective view showing the structure of an embodiment of an exposure scanner in the exposure system of FIG. 1;

FIG. 3A is a plan view showing an example of light-exposed regions formed on the exposure surface of a substrate by exposure heads of the exposure scanner of FIG. 2, and FIG. 3B is a plan view showing an example of an array of exposure areas realized by the individual exposure heads;

FIG. 4 is a schematic plan view showing an example of DMD arrangement in the exposure heads of the exposure system as shown in FIG. 1;

FIG. 5 is a block diagram showing the structure of an embodiment of an electrical control system in the exposure system to which the present invention is applicable;

FIG. 6 is a block diagram showing a schematic structure of an embodiment of an image transformation processing device which is applied to the drawing point data obtaining apparatus of the present invention for carrying out the drawing point data obtaining method of the present invention;

FIGS. 7A and 7B are diagrams illustrating effects of the image transformation processing device of FIG. 6;

FIG. 8 is a partially enlarged view of FIG. 7A;

FIGS. 9A and 9B are diagrams illustrating another effects of the image transformation processing device of FIG. 6;

FIGS. 10A and 10B are diagrams illustrating still another effects of the image transformation processing device of FIG. 6;

FIG. 11 is a flow chart showing an example of a flow of offline data input processing in a data input processing unit of the drawing point data obtaining apparatus of FIG. 5;

FIG. 12 is a flow chart showing an example of a flow of rotation and scaling processing in the image transformation processing device of FIG. 6;

FIG. 13 is a flow chart showing an example of a flow of online exposure processing in the exposure system of FIGS. 1 and 5;

FIG. 14 is a block diagram showing a schematic structure of an embodiment of an exposure point data obtaining device which is applied to the drawing point data obtaining apparatus of the present invention for carrying out the drawing point data obtaining method of the present invention;

FIG. 15 is a schematic diagram showing the relationship on a substrate which is ideal in shape between reference marks and information about passing points of a given micromirror;

FIG. 16 is a diagram illustrating a method of obtaining exposure track information of a given micromirror;

FIG. 17 is a diagram illustrating a method of obtaining exposure point data based on the exposure track information of a given micromirror;

FIG. 18 is an enlarged view of a part in the upper-left corner of FIG. 17;

FIG. 19 is a diagram showing exposure point data (mirror data) strings for the respective micromirrors;

FIG. 20 is a diagram showing pieces of frame data; and

FIGS. 21A and 21B are diagrams illustrating a conventional image transformation processing method.

### DETAILED DESCRIPTION OF THE INVENTION

A detailed description will be given below through preferred embodiments shown in the accompanying drawings on the drawing point data obtaining method and apparatus and drawing method and apparatus according to the present invention.

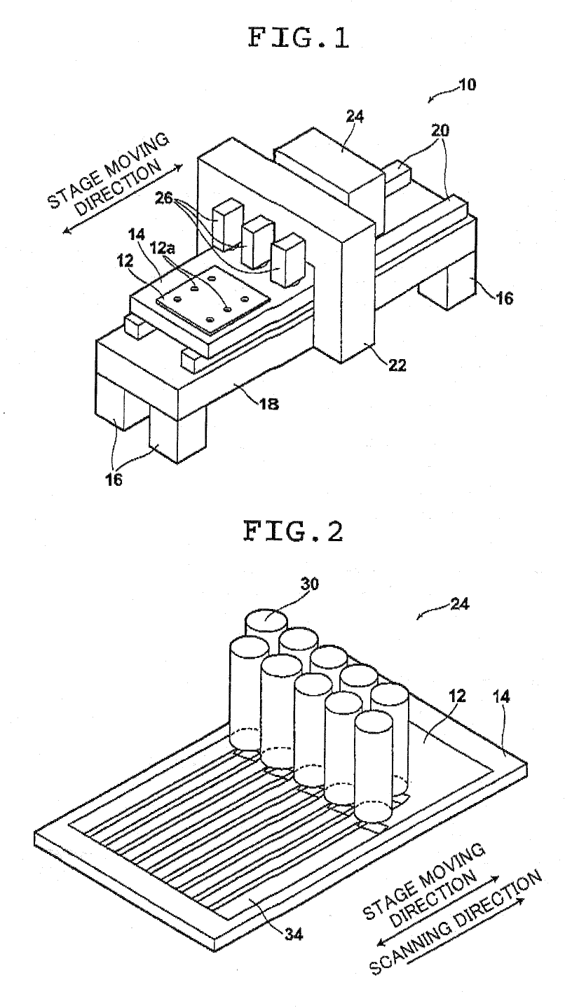

FIG. 1 is a perspective view showing a schematic structure of an embodiment of an exposure system to which the drawing apparatus of the present invention for carrying out the drawing method of the present invention is applicable. The exposure system as shown is a system for forming by exposure various patterns such as wiring patters to be formed on layers of a multilayer printed wiring board, and is characterized by the method of obtaining the exposure point data used for forming a pattern by exposure. Before this feature is addressed, the schematic structure of the exposure system is described first.

An exposure system 10 shown in FIG. 1 has a movable stage 14, two guides 20, a table 18, four legs 11, a gate 22, an exposure scanner 24, and multiple cameras 26. The movable stage 14, flat and rectangular in shape, is disposed such that its length runs in a stage moving direction, and holds a substrate 12 on a surface thereof by suction. The guides 20 extend in the stage moving direction to support the movable stage 14 in such a manner that the movable stage 14 can move back and forth in the stage moving direction. The table 18 is a thick plate on which the guides 20 extending along the stage moving direction are set. The legs 16 support the table 18. The gate 22 has an angular “C” shape, and is placed at the center of the table 18 over and across the moving path of the movable stage 14. The arms of the C-shaped gate 22 are fixed to the lateral sides of the table 18, respectively. The exposure scanner 24 is placed on one side of the gate 22 in the stage moving direction to form, by exposure, a given pattern such as a wiring pattern on the substrate 12 held on the movable stage 14. The cameras 26 are placed opposite to the exposure scanner 24 across the gate 22 to detect the positions of the front and rear edges of the substrate 12 and the positions of multiple circular reference marks 12a, which are provided in the substrate 12 in advance.

The reference marks 12a in the substrate 12 are, for example, holes formed in the substrate 12 based on the predetermined reference mark position information. Instead of holes, lands, vias, or etching marks may be employed as the reference marks 12a. Also, a given pattern that is already formed on the substrate 12, for example, a pattern on a layer below the one that is about to be exposed to light, may be used as the reference marks 12a. FIG. 1 shows only six reference marks 12a, but in practice, numerous reference marks 12a are provided in the substrate 12.

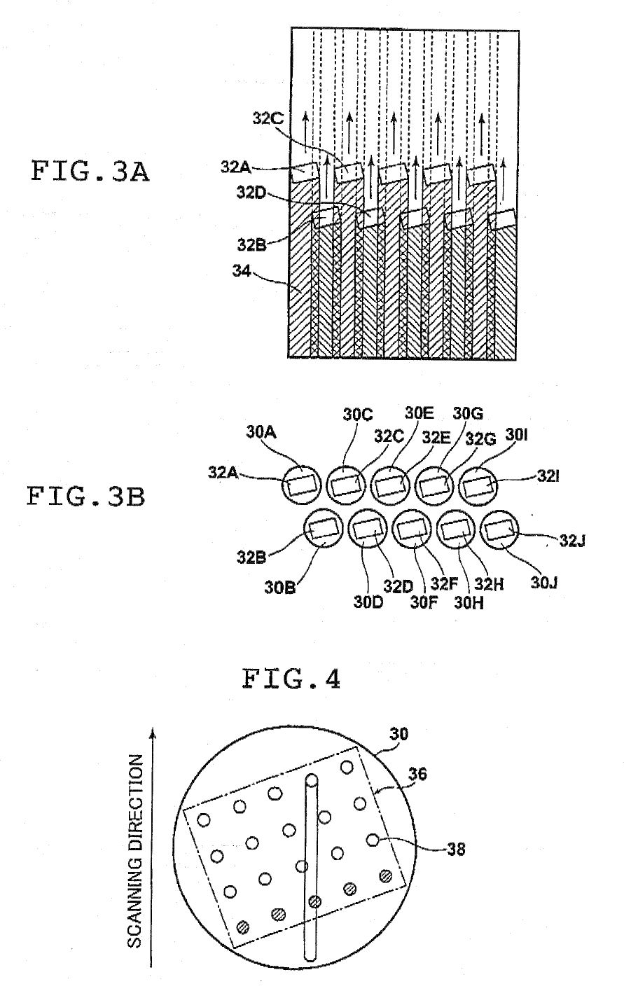

The exposure scanner 24 and the cameras 26 are attached to the gate 22 to be fixedly placed above the moving path of the movable stage 14. The exposure scanner 24 and the cameras 26 are connected to a controller 52 which controls the scanner 24 and the cameras 26 as will be described later with reference to FIG. The exposure scanner 24 in the example of FIG. 1 has, as shown in FIG. 2 and FIG. 3B, ten exposure heads 30 (30A to 30J) which are arrayed in a matrix-like form of two rows and five columns.

Set inside each exposure head 30 as shown in FIG. 4 is a digital micromirror device (DMD) 36, which is a spatial light modulator (SLM) for spatially modulating an incident beam of light. The DMD 36 is composed of numerous micromirrors 38 which are arrayed two-dimensionally in orthogonally intersecting directions. The DMD 36 is installed such that the column direction of the micromirrors 38 is at a specified tilt angle 0 to the scanning direction. This makes an exposure area 32 of each exposure head 30 a rectangular area tilted with respect to the scanning direction. As the stage 14 moves, each exposure head 30 forms a belt-like exposed region 34 on the substrate 12. A laser light source or the like can be employed as a not-shown light source for emitting a beam of light incident on the exposure heads 30.

On/off control of the DMD 36 in each exposure head 30 is such that the micromirrors 38 are turned on and off separately from one another. As a result, the substrate 12 is exposed to light in a dot pattern (black/white) corresponding to the images (beam spots) of the micromirrors 38 of the DMD 36. The belt-like exposed region 34 described above is formed from two-dimensionally arrayed dots which correspond to the micromirrors 38 shown in FIG. 4. The two-dimensional array dot pattern is slanted with respect to the scanning direction so that dots lined up in the scanning direction fill the gaps between dots lined up in a direction that intersects the scanning direction. High resolution is thus obtained. Depending oil how the tilt angle is adjusted, some dots may not be put into use. For example, hatched dots in FIG. 4 are not used and the micromirrors 38 of the DMD 36 that correspond to these out-of-use dots are kept turned off.

The exposure heads 30 linearly arranged in one row and the exposure heads 30 also linearly arranged in the other row are staggered regularly so that each belt-like exposed region 34 partially overlaps its adjacent exposed regions 34 as shown in FIGS. 3A and 3B. For example, the part between the leftmost exposure area 32A in the first row and the exposure area 32C on the right of the exposure area 32A, which otherwise would be left unexposed to light, can thus be exposed to light by the leftmost exposure area 32B in the second row. Similarly, the part between the exposure area 32B and the exposure area 32D on the right of the exposure area 32B, which otherwise would be left unexposed to light, is exposed to light by the exposure area 32C.

Main electrical components of the exposure system 10 will be described next The following description takes rotation and scaling, namely enlargement/reduction, as a typical example of image transformation processing. However, the present invention is not limited thereto and is applicable to other types of image transformation processing such as arbitrary transformation if there is similarity.

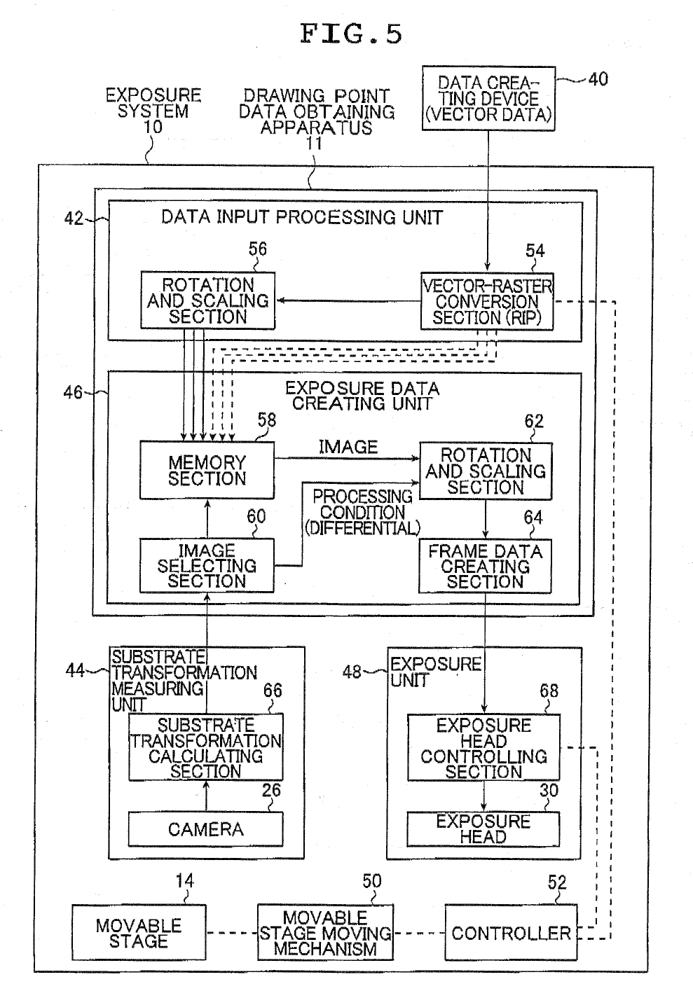

The exposure system 10 has, as shown in FIG. 5, a data input processing unit (hereinafter simply referred to as data input unit) 42, a substrate transformation measuring unit 44, an exposure data creating unit 46, an exposure unit 48, a movable stage moving mechanism (hereinafter simply referred to as moving mechanism) 50, and a controller 52. The data input unit 42 receives vector data from a data creating device 40, converts the vector data into raster data, and creates multiple sets of transformed image data by performing image transformation (rotation, scaling) processing on the raster data with multiple different transformation amounts such as rotation angles and scaling factors which are predetermined. The substrate transformation measuring unit 4 4 uses the cameras 26 to measure the transformation amount (such as rotation angle and scaling factor) of the substrate 12 on the movable stage 14 that is to be actually exposed to light. The exposure data creating unit 46 maintains or keeps the sets of transformed image data obtained by the data input unit 42, chooses one set out of the sets of transformed image data that has been obtained through processing with the transformation amount (rotation angle, scaling factor) closest to that measured by the substrate transformation measuring unit 44, performs image transformation (rotation, scaling) processing on the chosen set of transformed image data with the differential between the two transformation amounts, the measured one and the closest thereto, alone as a processing condition, and thus creates, as exposure data (drawing point data), the transformed image data that is adapted to the transformation amount (such as rotation angle and scaling factor) of the substrate 12 on the movable stage 14 that is to be actually exposed to light. The exposure unit 48 exposes the substrate 12 to light through the exposure heads 30 based on the exposure data created by the exposure data creating unit 46. The moving mechanism 50 moves the movable stage 14 in the stage moving direction. The controller 52 takes overall control of the exposure system 10.

In the exposure system 10, the data creating device 40 has a computer aided manufacturing (CAM) station and outputs vector data that represents a wiring pattern to be formed by exposure to the data input unit 42.

The data input unit 42 has a vector-raster conversion section (raster image processor: RIP) 54 and a rotation and scaling section 56. The vector-raster conversion section 54 receives the vector data representing a wiring pattern to be formed by exposure that is outputted from the data creating device 40, and converts the received vector data into raster data (bitmap data). The rotation and scaling section 56 uses the obtained raster data as original image data, and performs specified previous rotation and scaling processing on the original image data with a predetermined rotation angle and a predetermined scaling factor as processing conditions to obtain a set of transformed image data. The rotation and scaling section 56 repeats the above previous processing with multiple different rotation angles and multiple different scaling factors which are predetermined, and obtains multiple sets of transformed image data, accordingly.

The exposure data creating unit 46 has a memory section 58, an image selecting section 60, a rotation and scaling section 62, and a frame data creating section 64. The memory section 58 receives and stores multiple sets of transformed image data, which have been obtained by the rotation and scaling section 56 of the data input unit 42 with the predetermined different rotation angles and scaling factors, in an individual manner. The image selecting section 60 chooses one set out of the sets of transformed image data that has been obtained with the transformation amount (rotation angle, scaling factor) closest to the transformation amount of the substrate 12 to be actually exposed to light, which is outputted from the substrate transformation measuring unit 44, and calculates, as a processing condition, the differential between the transformation amount (rotation angle, scaling factor) of the transformed image thus selected and the measured transformation amount (rotation angle, scaling factor) of the substrate 12 that is to be actually exposed to light. The rotation and scaling section 62 receives the processing condition (differential) outputted from the image selecting section 60, and receives, as temporary transformed image data, a set of transformed image data of the transformed image selected by the image selecting section 60 that is outputted from the memory section 59. The rotation and scaling section 62 performs specified image transformation (rotation, scaling) processing in accordance with the received differential (processing condition) on the temporary transformed image data selected, to thereby obtain a set of transformed image data finally as drawing (exposure) point data. The frame data creating section 64 maps the drawing (exposure) point data obtained by the rotation and scaling section 62 such that the data corresponds to the individual micromirrors 38 of the DMD 36 in the exposure head 30, so as to make the data into frame data as an aggregation of multiple pieces of drawing (exposure) data which are to be given to all the micromirrors 38 of the DMD 36 for the purpose of drawing by exposure through the micromirrors 38 of the DMD 36.

The substrate transformation measuring unit 44 has the cameras 26 and a substrate transformation calculating section 66. The cameras 26 pick up images of the reference marks 12a formed on the substrate 12 and images of the front and rear edges of the substrate 12 The substrate transformation calculating section 66 calculates, from the images of the reference marks 12a picked up by the cameras 26, or from the picked-up images of the reference marks 12a and the front and rear edges of the substrate 12, the transformation amounts of the substrate 12 that is to be actually exposed to light with respect to the reference position and size, to be more specific, the rotation angle of the substrate 12 with respect to the reference position and the scaling factor, such as enlargement or reduction factor, of the substrate 12 with respect to the reference size.

The exposure unit 49 has an exposure head controlling section 68 and the exposure heads 30. The exposure head controlling section 68 controls the exposure heads 30 such that exposure is carried out through the DMDs 36 in the exposure heads 30 based on the frame data (exposure data) created by the frame data creating section 64 of the exposure data creating unit 46 and given to the DMDs 36 (all the micromirrors 38 thereof) in the exposure heads 30. The exposure heads 30 having the multiple DMDs 36 modulate an exposure beam such as a laser beam with the individual micromirrors 38 under control of the exposure head controlling section 68 to form a desired pattern on the substrate 12 by exposure with the modulated exposure beam.

The moving mechanism 50 moves the movable stage 14 in the stage moving direction under control of the controller 52. Any known structure can be employed for the moving mechanism 50 as long as it allows the movable stage 14 to move back and forth along the guides 20.

The controller 52 is connected to the vector-raster conversion section 54 of the data input unit 42, the exposure head controlling section 68 of the exposure unit 48, the moving mechanism 50, and so forth to control these and other components of the exposure system 10 as well as the entire exposure system 10.

In the exposure system 10 shown in FIG. 5, the data input unit 42 and the exposure data creating unit 46 constitute the drawing point data obtaining apparatus of the present invention which carries out the drawing point data obtaining method of the present invention.

It can therefore be expressed that the exposure system 10 shown in FIG. 5 has a drawing point data obtaining apparatus 11, which includes the data input unit 42 and the exposure data creating unit 46, the substrate transformation measuring unit 44, the exposure unit 48, the moving mechanism 50 for the movable stage 14, and the controller 52.

The exposure system 10 of FIG. 5 may be modified such that, with processing conditions (rotation angle, scaling factor, and the like) being set as parameters, the vector-raster conversion section 54 receives from the data creating device 40 multiple sets of transformed image data which correspond to multiple parameters to convert them into raster data, or internally creates them as raster data, to output the raster data directly to the memory section 58 of the exposure data creating unit 46 where the data is stored, as indicated by dotted lines in the figure.

Details of how the respective components described above operate will be given later.

In the exposure system 10 (drawing point data obtaining apparatus 11) of the present invention shown in FIG. 5, the rotation and scaling section 56 of the data input unit 42 and the rotation and scaling section 62 of the exposure data creating unit 46 are different from each other in processing condition (rotation angle, scaling factor) and input data to be processed, that is to say, the section 56 subjects the raster data (original image data) outputted from the vector-raster conversion section 54 of the data input unit 42 to processing under conditions with predetermined values, while the section 62 subjects the temporary transformed image data chosen by the image selecting section 60 of the exposure data creating unit 46 and read out from the memory section 58 to processing in accordance with the differential calculated as a processing condition. Regardless of the differences, both the rotation and scaling sections 56 and 62 can employ any processing means or processing method as long as desired image transformation (rotation, scaling) processing is accomplished under specified processing conditions. In other words, there are no particular limitations on the processing means and processing method themselves, and the processing means and method employed to carry out image transformation (rotation, scaling) processing may be the same or different between the rotation and scaling sections 56 and 62.

The following description is made assuming that the rotation and scaling sections 56 and 62 use the same processing means and processing method.

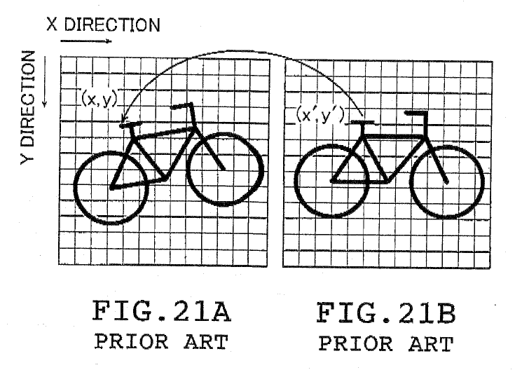

In the rotation and scaling section 62 of the exposure data creating unit 46 in the drawing point data obtaining apparatus 11 of the present invention (exposure system 10), the processing condition (transformation amount such as rotation angle and scaling factor) used is a differential and, accordingly, the transformation amount such as rotation angle and scaling factor is small. This enables the drawing point data obtaining apparatus 11 of the present invention to increase the length of addresses read in succession in the same line and increase continuous addressing, thereby decreasing editing places at which lines of addresses to be read are switched, and consequently reducing discontinuous addressing, even when the conventional direct mapping shown in FIGS. 21A and 21B is employed as the image transformation (rotation, scaling) processing executed in the rotation and scaling section 62. Imaging point data can thus be Created quicker. The rotation and scaling section 56 of the data input unit 42 also can employ the conventional direct mapping method because the rotation and scaling section 56 can execute image transformation processing prior to actual exposure processing and the like, and can afford the time necessary for a large transformation amount and increased discontinuous addressing.

Still, considering that the direct mapping is a time-consuming method when used in image transformation (rotation, scaling) processing as described above, it is preferable to employ the image transformation processing device that is proposed by the inventor of the present invention in Japanese Patent Application No. 2006-89958 (JP 2006-287534 A) filed by the applicant of the present invention and will be described later, or the drawing point data obtaining device that uses drawing point data tracking called a beam tracing method and is proposed by the inventor of the present invention in Japanese Patent Application No. 2005-103788 (JP 2006-309200 A) filed by the applicant of the present invention.

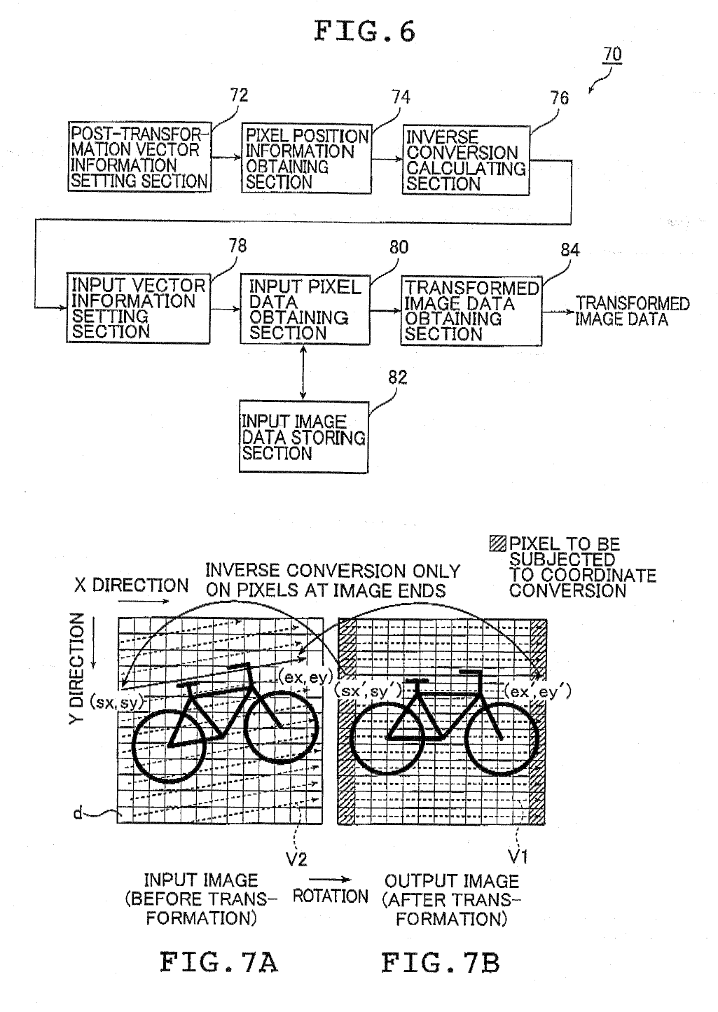

FIG. 6 is a block diagram of an embodiment of the image transformation processing device used in the drawing point data obtaining apparatus which carries out the drawing point data obtaining method of the present invention.

An image transformation processing device 70 shown in FIG. 6 is a device applied to the rotation and scaling sections 56 and 62. The image transformation processing device 70 has a post-transformation vector information setting section 72, a pixel position information obtaining section 74, an inverse conversion calculating section 76, an input vector information setting section 78, an input pixel data obtaining section 80, a transformed image data obtaining section 84, and an input image data storing section 82. The post-transformation vector information setting section 72 is for setting post-transformation vector information, which connects pixel position information indicating where pixel data is located in transformed image data to be obtained. The pixel position information obtaining section 74 obtains some of pixel position information on a post-transformation vector which is represented by the post-transformation vector information set by the post-transformation vector information setting section 72. The inverse conversion calculating section 76 performs an inverse conversion calculation only on the partial pixel position information obtained by the pixel position information obtaining section 74, to thereby obtain inversely-converted pixel position information in the input image data that corresponds to the partial pixel position information. The input vector information setting section 78 is for setting original vector information in input image data, which connects the inversely-converted pixel position information obtained by the inverse conversion calculating section 76. The input pixel data obtaining section 80 obtains, from input image data, input pixel data on an input vector which is represented by the input vector information set by the input vector information setting section 78. The transformed image data obtaining section 84 obtains the input pixel data obtained by the input pixel data obtaining section 80 as the pixel data in the position which is indicated by the pixel position information on the post-transformation vector to thereby obtain transformed image data. The input image data storing section 82 stores input image data.

Now a description is given on the operation of the image transformation processing device 70. A method of obtaining transformed image data that is shown in FIG. 7B by rotating input image data that is shown in FIG. 7A clockwise is described first.

The vector-raster conversion section 54 of the data input unit 42 in the exposure system 10 shown in FIG. 5 outputs raster data (original image data) first, or the memory section 58 of the exposure data creating unit 46 outputs the temporary transformed image data which is chosen. The outputted image data is stored as input image data in the input image data storing section 82 shown in FIG. 6. At the same time, the post-transformation vector information setting section 72 sets post-transformation vector information. In the post-transformation vector information setting section 72, pixel position information which indicates the positions of individual pixels in the transformed image data to be obtained is set beforehand. For example, coordinate values indicating the positions of the pixels may be set as the pixel position information.

The post-transformation vector information setting section 72 sets post-transformation vector information VI which connects the leftmost pixel position information and the rightmost pixel position information by a horizontal straight line as shown in FIG. 7B. In FIG. 7B, the leftmost pixel position information and rightmost pixel position information are hatched. The post-transformation vector information VI, which, in this embodiment, connects the leftmost pixel position information and the rightmost pixel position information by a horizontal, straight line, may connect the leftmost and the rightmost pixel position information by a spline curve or other curve instead of a straight line. Also, the post-transformation vector information V1 does not always need to be set such that the leftmost pixel position information and the rightmost pixel position information are connected. In short, the post-transformation vector information V1 can be set in any way as long as it connects predetermined multiple pieces of pixel position information by a straight line or a curve, and each piece of pixel position information of the transformed image data belongs to any one of the pieces of post-transformation vector information V1.

The post-transformation vector information V1 set as described above is outputted to the pixel position information obtaining section 74. The pixel position information obtaining section 74 obtains some of pixel position information on a post-transformation vector represented by the inputted post-transformation vector information. In this embodiment, the pixel position information that is hatched in FIG. 7B is obtained as such partial pixel position information. The pixel position information obtaining section 74, which, in this embodiment, obtains pixel position information at both ends of a post-transformation vector represented by the post-transformation vector information V1, may obtain pixel position information at other locations, and may obtain more than two pieces of pixel position information. However, the pixel position information obtaining section 74 should obtain only some of pixel position information in post-transformation vector information, not all of the pixel position information.

The partial pixel position information obtained in a manner described above is outputted to the inverse conversion calculating section 76, where an inverse conversion calculation is performed only on the partial pixel position information. Because transformation in this embodiment is clockwise rotation of input image data as mentioned above, an inverse conversion calculation for the transformation opposite to such transformation, namely, counterclockwise rotation, is performed on the partial pixel position information. Specifically, the hatched leftmost pixel position information (sx′, sy′) in an initial portion in FIG. 7B and the hatched rightmost pixel position information (ex′, ey′) in a terminal portion in the figure are made into the inversely-converted pixel position information, (sx, sy) and (ex, ey), shown in FIG. 7A through an inverse conversion calculation expressed by the following expressions (the rotation angle e being given counterclockwise):

sx=sx′cos θ+sy′ sin θ

sy=−sx′sin θ+sy′ cos θ

ex=ex′cos θ+ey′ sin θ

ey=−ex′sin θ+ey′ cos θ

The inverse conversion calculation in this embodiment is a calculation representing counterclockwise rotation in order to obtain transformed image data that is input image data rotated clockwise. The inverse conversion calculation is not limited thereto and, in the case where a different type of transformation is performed, an appropriate calculation representing an opposite to that transformation is employed. For instance, when transformed image data to be obtained is input image data enlarged by a given enlargement factor, the inverse conversion calculation is a calculation representing reduction by a reduction factor corresponding to the enlargement factor. Specifically, a calculation employed as the inverse conversion calculation when input image data is to be enlarged by, for example, two times represents reduction that reduces the distance between pieces of pixel position information belonging to the same vector information to ½. On the other hand, when transformed image data to be obtained is input image data reduced by a given reduction factor, the inverse conversion calculation is a calculation representing enlargement by an enlargement factor corresponding to the reduction factor. When transformed image data is to be obtained by shifting, in a given direction, pixel data that is in a given portion of input image data, a calculation employed as the inverse conversion calculation is for a shift of pixel position information in a direction opposite to the above direction.

The inversely-converted pixel position information that corresponds to the hatched pixel position information in FIG. 7B is thus obtained and outputted to the input vector information setting section 78. The input vector information setting section 78 sets input vector information V2 in the input image data as shown in FIG. 7A. Specifically, the input vector information V2 as shown in FIG. 7A is obtained by connecting, by a straight line, the inversely-converted pixel position information that corresponds to the pixel position information at both ends of a post-transformation vector represented by the post-transformation vector information. In this embodiment, the input vector information V2 is set by connecting the inversely-converted pixel position information by a straight line as shown in FIG. 7A. However, the present invention is not limited thereto, and the input vector information V2 may be set by connecting the inversely-converted pixel position information by a spline curve or other curve instead of a straight line.

The thus set input vector information V2 is outputted to the input pixel data obtaining section 80, which obtains, from the input image data, input pixel data d on an input vector represented by the entered input vector information V2. Specifically, the input pixel data obtaining section 80 sets, based on the entered input vector information, reading information which indicates at what pitch the N-th to L-th pieces of pixel data in the M-th row in the input image data are to be read, and reads the input pixel data from the input image data stored in the input image data storing section 82 in accordance with the reading information.

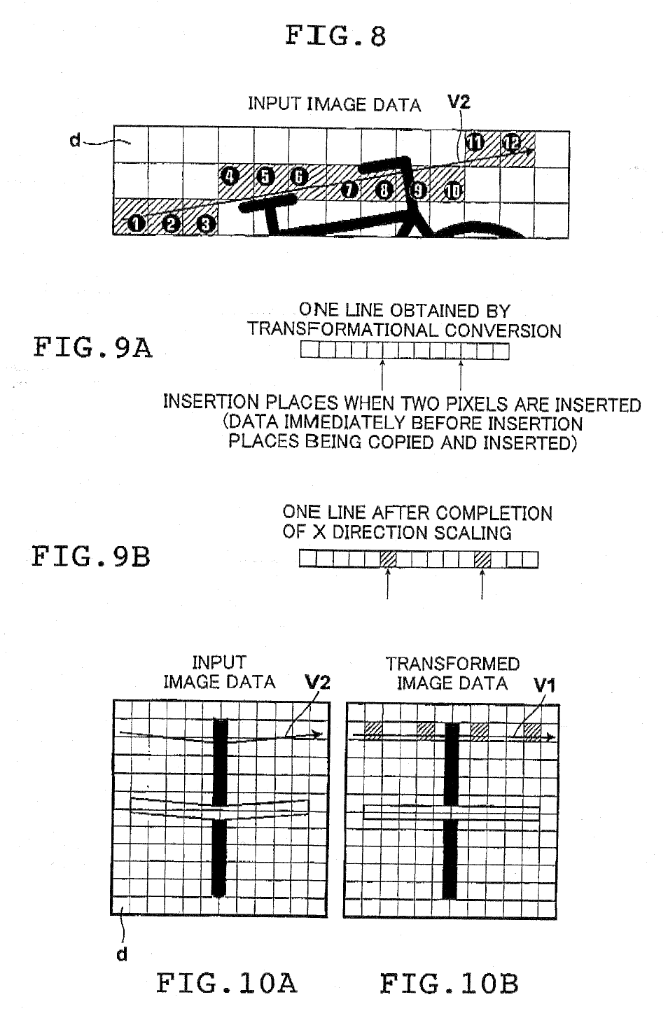

FIG. 8 is a partial enlarged view of FIG. 7A. When the original vector information V2 represents an original vector as shown in FIG. 8, for example, the input pixel data obtaining section 80 sets the reading information indicating that the first to third pieces of input pixel data d in the third row, the fourth to tenth pieces of input pixel data d in the second row, and the eleventh and twelfth pieces of input pixel data d in the first row are to be read in succession at a pitch of one pixel, and reads out the hatched input pixel data d of FIG. 8 from the input image data in accordance with the reading information. In the example of FIG. 8, in obtaining one row of transformed image data that is composed of twelve pixels, lines (locations) from which the input pixel data d is read are switched discontinuously at two places, one between the third piece of data in the third row and the fourth in the second row, and the other between the tenth piece of data in the second row and the eleventh in the first row, meaning that there are two editing places where discontinuous addressing has occurred.

In the case where a position indicated by the inversely-converted pixel position information is out of the range of input image data and no input pixel data is in the position, input pixel data near the position indicated by the inversely-converted pixel position information is read as the input pixel data that corresponds to the inversely-converted pixel position information. The reading pitch in reading information is not necessarily a one-pixel pitch; for example, one piece of input pixel data may be read in two or more readings, or input pixel data may be read in a skipping manner. The input vector information may contain a component on the reading pitch as described above.

In this embodiment, the input vector information setting section 78 sets the input vector information V2 based on the inversely-converted pixel position information which is obtained by the inverse conversion calculating section 76. However, it is not always necessary to set the input vector information V2. An alternative is, for example, to input the inversely-converted pixel position information directly to the input pixel data obtaining section 80, where reading information, which indicates at what pitch the N-th to L-th pieces of pixel data in the M-th row in the input image data are to be read, is set based on the inversely-converted pixel position in formation inputted, and input pixel data is read out from the input image data stored in the input image data storing section 82 in accordance with the reading information.

The input pixel data read by the input pixel data obtaining section 80 in a manner described above is outputted to the transformed image data obtaining section 84, and the transformed image data obtaining section 84 obtains the input pixel data d, which is obtained based on the input vector information V2 in a manner described above, as the pixel data of the pixel position information on the post-transformation vector that is represented by the post-transformation vector information V1 corresponding to the input vector information V2. In this regard, post-transformation vector information V1 corresponding to input vector information V2 refers to the post-transformation vector information V1 from which input vector information V2 has been obtained through inverse conversion calculation. For each of the pieces of post-transformation vector information corresponding to the pieces of input vector information V2, the pixel data of the individual pieces of pixel position information is obtained in a manner described above, and the transformed image data is obtained after pixel data is obtained for every piece of pixel position information, and for every piece of post-transformation vector information as well.

The image transformation processing device 70 of the above-mentioned embodiment sets the post-transformation vector information V1 which connects pixel position information indicating where pixel data is located in the transformed image data to be obtained, obtains some of pixel position information on a post-transformation vector represented by the set post-transformation vector information V1, performs an inverse conversion calculation representing a transformation opposite to the above-mentioned transformation on the obtained partial pixel position information alone to obtain inversely-converted pixel position information in input image data that corresponds to the partial pixel position information, sets the input vector information V2 which connects the obtained inversely-converted pixel position information in the input image data, obtains, from the input image data, the input pixel data d on an input vector represented by the set input vector information V2, and obtains the transformed image data by obtaining the input pixel data d as the pixel data in a position indicated by the pixel position information on the post-transformation vector. Since only some of pixel position information in transformed image data receives an inverse conversion calculation, transformed image data can be obtained more quickly than the conventional case in which an inverse conversion calculation is performed on every piece of pixel position information.

In transformation of input image data by rotation as above, the transformed image data remains truer to the input image data if the rotation angle is smaller. The transformed image data is much truer to the input image data particularly when the input image data is rotated about one to two degrees. In other words, the smaller the rotation angle is in the transformation processing by rotation, the larger the number of the pixels is that are read out in succession from one row of input image data. As a consequence, in obtaining one row of transformed image data, rows of the input image data are switched for the reading of pixels less frequently, that is to say, editing places involved in discontinuous addressing are reduced, which leads to a more quick acquisition of transformed image data as compared with the case of a larger rotation angle. This speed-up effect is more prominent when the input image data is compressed image data, because fewer editing places permit the decompressing and compressing of data to be carried out fewer times.

The above-mentioned embodiment describes a case of transforming the input image data by rotation. In the case where scaling is performed in addition to the above-mentioned rotation, assuming that scaling is performed on the image shown in FIG. 7A to obtain the image shown in FIG. 7B, and that the rotation angle is given as e (counterclockwise), and the scaling factors in the X and Y directions are given as mx and my, respectively, the hatched leftmost pixel position information (sx′, sy′) and hatched rightmost pixel position information (ex′, ey′) of FIG. 7B are made into the inversely-converted pixel position information, (sx, sy) and (ex, ey), through an inverse conversion calculation expressed by the following expressions:

sx=(sx′ cos θ+sy′ sin θ)/mx

sy=(−sx′ sin θ+sy′ cos θ)/my

ex=(ex′ cos θ+ey′ sin θ)/mx

ey=(−ex′ sin θ+ey′ cos θ)/my

In scaling in the Y direction, the excess or shortage in number of pixels in the Y direction, namely, the excess or shortage in number of lines (rows) (number of pieces of vector information V2) is expressed as (ey′−sy′−ey+sy) pixels or lines, and read lines (pieces of vector information V2) are decreased or increased by the number of excess or lacking lines.

In scaling in the X direction, the excess or shortage in number of pixels in the X direction is expressed as (ex′−sx′−ex+sx) pixels, and read pixels are decreased or increased by the number of excess or lacking pixels.

For instance, if one line obtained by a transformational conversion from FIG. 7A to FIG. 7B includes thirteen pixels arrayed as shown in FIG. 9A, and is short of two pixels in the X direction, the insertion place at which specified pixel data is inserted into the line is initially determined for every five pixels, to he more specific, between the fifth pixel and the sixth pixel and between the tenth pixel and the eleventh pixel in the example shown in FIG. 9A, then the data about the pixels immediately before the insertion places, data about the fifth pixel and data about the tenth pixel in this case, are assigned for the insertion, copied, and introduced into the line. The line is thus subjected to the scaling in the X direction before the processing is completed as shown in FIG. 9. In the line shown in FIG. 9B, hatched portions represent the inserted pixels.

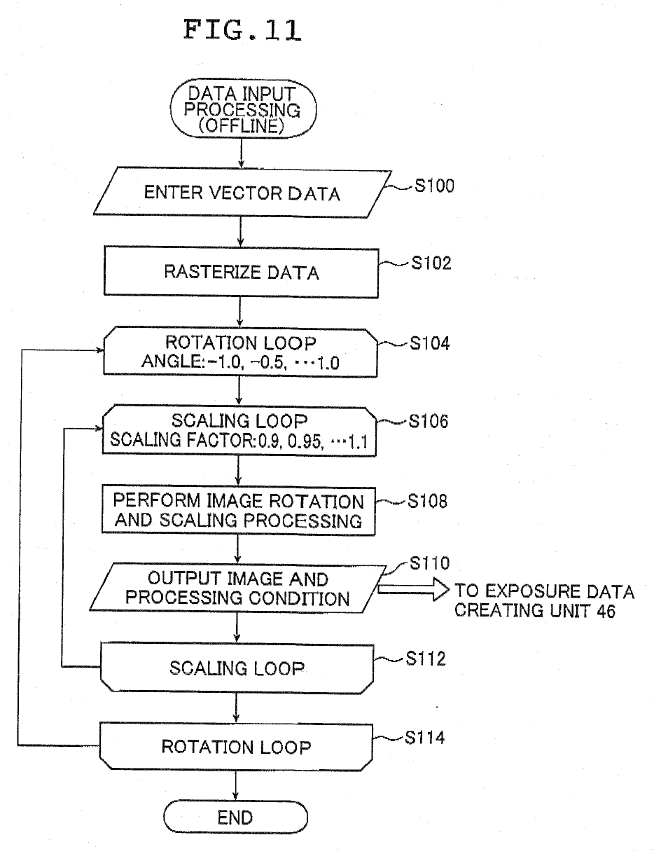

Apart from the rotation and scaling performed in the above-mentioned embodiments, the image transformation processing method of the present invention may be applied to arbitrary transformation. FIGS. 10A and 10B show an example of arbitrary transformation.

To obtain transformed image data shown in FIG. 10B through arbitrary transformation of input image data shown in FIG. 10A, the post-transformation vector information setting section 72 sets, for example, the post-transformation vector information V1 that connects the pixel position information of the hatched portions in FIG. 10B by a horizontal, straight line. Out of the pixel position information on the post-transformation vector represented by the set post-transformation vector information, a part, namely, the pixel-position information of the hatched portions in FIG. 10B is obtained by the pixel position information obtaining section 74, and this partial pixel position information alone receives an inverse conversion calculation in the inverse conversion calculating section 76. The inversely-converted pixel position information that corresponds to the pixel position information of the hatched portions in FIG. 10B is thus obtained.

The inversely-converted pixel position information obtained in a manner described above is outputted to the input vector information setting section 78, which sets input vector information V2 in the input image data as shown in FIG. 10A. Specifically, the input vector information V2 shown in FIG. 10A is obtained by connecting, by straight lines, the pieces of inversely-converted pixel position information that correspond to four pieces of pixel position information located on the post-transformation vector which is represented by the post-transformation vector information. The input pixel data obtaining section 80 then obtains, from the input image data, the input pixel data d on the input vector represented by the entered input vector information V2. The input pixel data read by the input pixel data obtaining section So in this manner is outputted to the transformed image data obtaining section 84. The transformed image data obtaining section 84 treats the input pixel data d, which is obtained based on the input vector information V2 in a manner described above, as the pixel data of the pixel position information on the post-transformation vector that is represented by the post-transformation vector information V1 corresponding to the input vector information V2. For each of the pieces of post-transformation vector information corresponding to the pieces of input vector information V2, the pixel data of the individual pieces of pixel position information is obtained in a manner described above, and the transformed image data is obtained after pixel data is obtained for every piece of pixel position information, and for every piece of post-transformation vector information as well.

Described next with reference to the drawings is how the exposure system 10 and its drawing point data obtaining apparatus 11 operate according to the present invention.

Offline data input processing will be described first which is performed in advance in the data input unit 42 of the drawing point data obtaining apparatus 11 of the exposure system 10 shown in FIG. 5. FIG. 11 is a flow chart showing an example of the flow of the offline data input processing which is performed by the data input unit 42 in the drawing point data obtaining apparatus 11 of FIG. 5.

First, the data creating device 40 creates vector data which represents a wiring pattern to be formed on the substrate 12 by exposure.

In Step S100, the created vector data is inputted to the vector-raster conversion section 54 of the data input unit 42 from the data creating device 40.

The vector data inputted from the data creating device 40 is converted into raster data in the vector-raster conversion section 54, and outputted to the rotation and scaling section 56 (Step S102).

The rotation and scaling section 56 sets the rotation angle and scaling factor of the substrate 12 at given values as processing condition parameters (Steps S104 and S106).

For example, in FIG. 11, the rotation angle is set in five stages from −1.0° to 1.0° at intervals of 0.5°, and the scaling factor is set in five stages from 0.9 to 1.1 at intervals of 0.05. The values of rotation angle and scaling factor to be selected as processing condition parameters are not limited to the above, but selected between appropriate upper and lower limits at appropriate intervals in accordance with the type of the substrate 12 and the pattern to be formed thereon.

The rotation angle and the scaling factor are set initially at −1.0° and 0.9°, respectively (Steps S104 and S106). The rotation and scaling section 56 performs rotation and scaling processing on the image (input image data) (Step S108) to obtain a set of transformed image data of this image. The image (input image data) rotation and scaling processing is executed by, for example, the image transformation processing device 70 described above with reference to FIG. 6, and transformed image data is obtained from the input image data through this processing. A description will be given later on how transformed image data is obtained in the image rotation and scaling processing executed by the image transformation processing device 70 in the rotation and scaling section 56.

The set of transformed image data thus obtained is outputted to and stored in the memory section 58 of the exposure data creating unit 46 along with the processing conditions, a rotation angle of −1.0° and a scaling factor of 0.9 (Step S110).

In the subsequent Step S112, it is decided to return to Step S106, which constitutes the scaling loop together with Step 112, in order to set the scaling factor otherwise as long as there remain any scaling factor parameters In this case, the setting of scaling factor is changed from 0.9 to 0.95, then the image rotation and scaling processing of Step S108 and the outputting of image (transformed image data) and processing conditions of Step S110 are performed again. The scaling loop between Step S106 and Step S112 is executed repeatedly until no scaling factor parameter is left for the execution,

When no scaling factor parameter is left for the execution after, for instance, the image rotation and scaling processing and the outputting of image and processing conditions are completed under a scaling factor set at 1.1 the processing flow leaves the scaling loop to reach the step next to Step S112, Step S114. In Step S114, it is decided to return to Step S104, which constitutes the rotation loop together with Step 114, in order to set the rotation angle otherwise as long as there remain any rotation angle parameters. In this case, the setting of rotation angle is changed from −1.0° to −0.5°, then the scaling loop of Step S106 through Step S112 is repeated again, that is to say, the image rotation and scaling processing and the outputting of image and processing conditions are repeated. The rotation loop between Step S104 and Step S114 is executed repeatedly until no rotation angle parameter is left for the execution.

When no rotation angle parameter is left for the execution after, for instance, the image rotation and scaling processing and the outputting of image and processing conditions are completed under a rotation angle set at 1.0°, the processing flow leaves Step S114, namely the rotation loop, and the offline data input processing is ended.

In this way, multiple sets of transformed image data, in this example, 25 sets of transformed image data which correspond to a total of 25 combinations of processing conditions, five rotation angles and five scaling factors, are stored in the memory 58.

Next, a description will be given on the image rotation and scaling processing of Step S108 in FIG. 11 which is executed by the rotation and scaling section 56, taking as a typical example the case of using the image transformation processing device 70 shown in FIG. 6 to obtain transformed image data. Details of the operation of the image transformation processing device 70 shown in FIG. 6 have been described above and will not be repeated here.

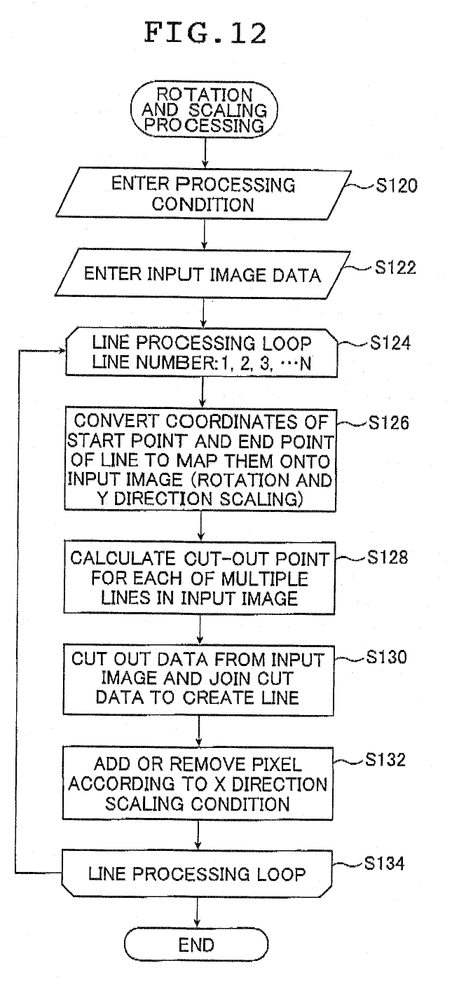

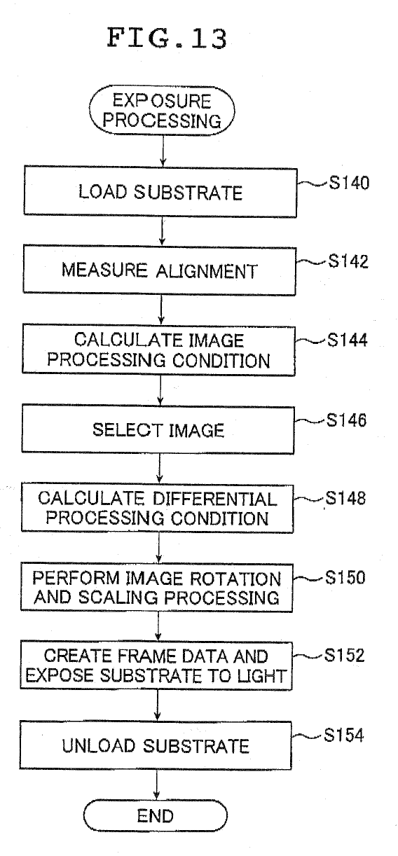

FIG. 12 is a flow chart showing an example of the flow of the rotation and scaling processing that is executed by the image transformation processing device 70 of FIG. 6. This flow is applicable to the image rotation and scaling processing of Step S150 in FIG. 13 as described later that is executed by the rotation and scaling section 62.

Processing conditions such as the rotation angle and scaling factor set in Steps S104 and S106 of the data input processing shown in FIG. 11 as described above are inputted (Step S120), while input image data (raster data) is inputted (Step S122) and stored in the input image data storing section

Based on the inputted rotation angle and scaling factor, the post-transformation vector information setting section 72 sets the post-transformation vector information V1, which connects the leftmost pixel position information (in a start-point portion) in the output image (transformed image) represented by the transformed image data to be obtained (raster data) and the rightmost pixel position information (in an end-point portion) in the output image by a horizontal, straight line as shown in FIG. 7B, in the output image with respect to the lines (line number 1, 2, 3, . . . , N) required. The post-transformation vector information V1 is set initially for the line with the line number 1 (Step S124).

Next, the coordinates of the start point and end point of the first line in the output image receive a coordinate conversion and are thereby mapped onto the input image (image to be transformed) represented by the input image data of FIG. 7A, with the rotation and the scaling in the Y direction being thus accomplished (Step S126). Specifically, the pixel position information obtaining section 74 obtains, out of the pixel position information on a post-transformation vector represented by the post-transformation vector information V1, the leftmost and rightmost pixel position information as above, and the inverse conversion calculating section 76 performs an inverse conversion calculation only on the leftmost and rightmost pixel position information to obtain the inversely-converted pixel position information that corresponds to the Leftmost and rightmost pixel position information. The inverse conversion calculation performed here is the one that is expressed by the above-mentioned expressions using a rotation matrix.

The inversely-converted pixel position information obtained in a manner described above is outputted to the input vector information setting section 78, which sets input vector information V2 in the input image data as shown in FIG. 7A. Specifically, the input vector information V2 shown in FIG. 7A is obtained by connecting, by a straight line, the inversely-converted pixel position information that corresponds to the leftmost and rightmost pixel position information located on a post-transformation vector which is represented by the post-transformation vector information.

The input vector information setting section 78 calculates locations where the obtained input vector information V2 crosses horizontal pixel lines (rows of pixels arrayed horizontally) in the input image, that is to say, calculates a cut-out point for each of multiple lines in the input image. In the example of FIG. 8, the position of the fourth pixel in the second row and that of the eleventh pixel in the first row are calculated (Step S128).

The input pixel data obtaining section 80 cuts out, from the individual lines, the input pixel data on the input vector represented by the entered input vector information V2 to read it, and sequentially joins the read input pixel data so as to create the first line of the output image data (Step S130).

Next, the number of excess or lacking pixels is calculated from the input vector information V2 and the post-transformation vector information V1 under the condition for scaling in the X direction in a manner described above, and pixels are removed or added accordingly if there is an excess or shortage of pixels (Step S132). The first line of transformed image data is thus obtained as the output, image data. The input pixel data read by the input pixel data obtaining section 80 in this manner is outputted to the transformed image data obtaining section 84. The transformed image data obtaining section 84 treats the input pixel data, which is obtained based on the input vector information V2 in a manner described above, as the pixel data of the first line pixel position information on the post-transformation vector represented by the post-transformation vector information V1 that corresponds to the input vector information V2.

In the subsequent Step S134, it is decided to return to Step S124, which constitutes the line processing loop together with Step 5134, in order to set the post-transformation vector information V1 in the output image to be obtained for the line with another line number as long as there remain any lines to be processed in the output image. In this case, the line to be processed is changed from the line with line number 1 to that with line number 2, then the image rotation and scaling processing of Step S126 through Step S132 is performed again. The line processing loop between Step S124 and Step S134 is executed repeatedly until no line to be processed is left for the execution, that is to say, until the line with line number N has been processed. Transformed image data is thus obtained for the individual lines in the output image.

When no line to be processed is left for the execution after, for instance, the image rotation and scaling processing is completed with the line with line number N, the processing flow leaves Step S134, namely the line processing loop, and the image rotation and scaling processing is ended.

For each of the pieces of post-transformation vector information corresponding to the pieces of input vector information V2, the pixel data of the individual pieces of pixel position information is obtained in a manner described above, and a set of transformed image data is obtained after pixel data is obtained for every piece of pixel position information, and for every piece of post-transformation vector information as well.

The thus obtained set of transformed image data is outputted from the rotation and scaling section 56 of the data input unit 42 to the memory section 58 of the exposure data creating unit 46 and stored therein.

The image rotation and scaling processing shown in FIG. 12 is described here as the processing executed by the rotation and scaling section 56 of the data input unit 42. However, as mentioned above, the image transformation processing device 70 shown in FIG. 6 is applicable to the rotation and scaling section 62 of the exposure data creating unit 46, which section is substantially identical to the section 56 except that the rotation angle differential and the scaling factor differential constitute processing conditions, and that the transformed image data chosen serves as input image data. The image rotation and scaling processing shown in FIG. 12 can therefore be executed by the rotation and scaling section 62, and a description on how the rotation and scaling section 62 executes the image rotation and scaling processing shown in FIG. 12 will be omitted.

Exposure processing performed in the exposure system 10 of the present invention is described next.

FIG. 13 is a flow chart showing an example of the flow of online exposure processing in the exposure system 10.

Prior to this online exposure processing, vector data representing a wiring pattern to be formed on the substrate 12 by exposure is created in the data creating device 40, inputted to the vector-raster conversion section 54 of the data input unit 42 in the drawing point data obtaining apparatus 11, and converted into raster data (original image data) in the section 54. The raster data is outputted to the rotation and scaling section 56, which obtains multiple sets of transformed image data by performing the processing under multiple processing conditions (combinations of the rotation angle and the scaling factor) on the raster data. The obtained sets of transformed image data are stored in the memory section 58 of the exposure data creating unit 46.

Meanwhile, the input of the vector data to the vector-raster conversion section 54 causes the controller 52, which controls the operation of the entire exposure system 10, to output a control signal to the moving mechanism 50. In response to the control signal, the moving mechanism 50 moves the movable stage 14 along the guides 20 upstream from the position shown in FIG. 1 to a specified initial position where the movable stage 14 is stopped to load and fix the substrate 12 onto the movable stage 14 (Step S140).

After the substrate 12 is fixed onto the movable stage 14, the controller 52 which controls the operation of the entire exposure system 10 outputs a control signal to the moving mechanism 50, causing the moving mechanism 50 to move the movable stage 14 at a desired speed downstream from the specified initial position which is defined rather upstream. It should be noted that the term “upstream” means “on or toward the right side in FIG. 1”, that is to say, “on or toward the side of the gate 22 on which the scanner 24 is attached to the gate 22”, and the term “downstream” means “on or toward the left side in FIG. 1”, that is to say, “on or toward the side of the gate 22 on which the cameras 26 are attached to the gate 22.”

At the time the substrate 12 on the movable stage 14 moved in a manner described above passes under the cameras 26, the substrate transformation measuring unit 44 conducts an alignment measurement. In the alignment measurement, the cameras 26 pick up an image of the substrate 12 and picked-up image data representing the picked-up image is inputted to the substrate transformation calculating section 66 of the substrate transformation measuring unit 44. The substrate transformation measuring unit 44 (substrate transformation calculating section 66) obtains, based on the inputted picked-up image data, detected position information which indicates the positions of the front and rear edges of the substrate 12 and the positions of the reference marks 12a in the substrate 12. From the detected position information indicating the positions of the front and rear edges and the positions of the reference marks 12a, the substrate transformation measuring unit 44 calculates the transformation amounts of the substrate 12, namely, the rotation angle by which the substrate is rotated and the scaling factor by which the substrate is enlarged or reduced (Step S142).

The detected position information on the front and rear edges and the reference marks 12a may be obtained by extracting linear edge images and circular images, or by any other known method. The detected position information on the front and rear edges and the reference marks 12a is obtained specifically as coordinate values. The origin for establishing coordinate values may be set on the corner selected from four corners of the substrate 12 in the picked-up image data, or at a predetermined point in the picked-up image data, or in the position of one of the reference marks 12a. The transformation amount such as rotation angle and scaling factor is obtained by a known calculation method, for example, by measuring or calculating the distance between the front or rear edge and a certain reference mark 12a, or between the reference marks 12a, and comparing the distance with a known standard value.

The rotation angle, scaling factor, and other transformation amounts of the substrate 12 measured and calculated in this way by the substrate transformation measuring unit 44 are outputted to the image selecting section 60 of the exposure data creating unit 46.

The image selecting section 60 receives the rotation angle, scaling factor, and other transformation amounts of the substrate 12 outputted from the substrate transformation measuring unit 44, and calculates, as the image processing conditions for the original image data that are used for creating exposure data for exposure with the exposure heads 30 of the exposure scanner 24, the rotation angle and scaling factor by which the original image data is to be rotated and scaled (Step S144). In this regard, if the DMDs 36 (arrays of the micromirrors 38) of the exposure heads 30 are tilted with respect to the scanning direction as shown in FIG. 4, the tilt angle should also be taken into account as a component of the rotation angle. Image processing conditions such as rotation angle and scaling factor may already be calculated by the substrate transformation calculating section 66 of the substrate transformation measuring unit 44.

The image selecting section 60 next chooses, out of multiple sets of transformed image data stored in the memory section 58 along with image processing conditions, one set of transformed image data whose rotation angle and scaling factor are closest to the rotation angle and scaling factor that have been calculated as image processing conditions (Step S146). The image selecting section 60 chooses one set of transformed image data by, for example, searching the memory section 58 with an image processing condition as a key

The image selecting section 60 then calculates a differential processing condition, which is the differential between an image processing condition of the chosen set of transformed image data and an image processing condition measured in the substrate 12 that is to be actually exposed to light. Specifically, the rotation angle differential and the scaling factor differential are calculated (Step S148).

The calculated differential processing conditions (rotation angle differential and scaling factor differential) are outputted from the image selecting section 60 to the rotation and scaling section 62. Also, the set of transformed image data chosen by the image selecting section 60 is outputted from the memory section 58 to the rotation and scaling section 62,

The rotation and scaling section 62 performs image rotation and scaling processing by using the differential processing conditions (rotation angle differential and scaling factor differential) outputted from the image selecting section 60 and the set of transformed image data outputted from the memory section 58.

Specifically, the rotation and scaling section 62 performs the rotation and scaling processing of FIG. 12 in the image transformation processing device 70 of FIG. 6 using the differential processing conditions, ire., the rotation angle differential and the scaling factor differential, as processing conditions and the chosen set of transformed image data as input image data to obtain transformed image data. The transformed image data thus obtained serves as drawing point data, for instance, pixel data (mirror data) that corresponds to the individual micromirrors 38 of the DMDs 36 in the exposure heads 30.

In the rotation and scaling processing performed by the rotation and scaling section 62, the rotation angle and scaling factor used as processing conditions are the differences between the rotation angle and scaling factor which are measured and those which are predetermined and are closest to the measured ones, so that necessary rotation and scaling are carried out with reduced rotation angle and scaling factor, much more reduced if the similarity is great. This results in a decrease in number of cut-out points in each of multiple lines in an input image, which are calculated in Step S128 of FIG. 12, or even a decrease in number of the lines that have cut-out points. In other words, more pixels in one line can be read in succession in reading out pixel data from input image data, and the editing places involved in discontinuous addressing are reduced in number. Consequently, even if the input image data is compressed image data, decompressing and compressing of data must be carried out fewer times, leading to a speed-up of processing.

In addition, conversion processing is quicker than in the conventional direct mapping because this example employs the image rotation and scaling processing of FIG. 12 executed in the image transformation processing device 70 and, accordingly, only the coordinates of the leftmost and rightmost pixels of an input image must receive a coordinate conversion.

The drawing point data (e.g., mirror data) obtained through the image rotation and scaling processing in Step S150 is outputted from the rotation and scaling section 62 to the frame data creating section 64.

The frame data creating section 64 creates, from the drawing point data (e.g., mirror data), frame data as an aggregation of pieces of exposure data which are to be given to the individual micromirrors 38 of the DMDs 36 in the exposure heads 30 upon exposure.

The frame data created by the frame data creating section 64 is outputted to the exposure head controlling section 68 of the exposure unit 48.

Meanwhile, the movable stage 14 is again moved upstream at a desired speed.

Exposure is started when the front edge of the substrate 12 is detected by the cameras 26 (or when the position of a region to be drawn of the substrate 12 is identified from the position of the stage 14 which is detected by a sensor). Specifically, a control signal based on the frame data is outputted from the exposure head controlling section 68 to the DMD 36 of each exposure head 30, and the exposure head 30 exposes the substrate 12 to light by turning on or off the micromirrors 38 of the DMD 36 in accordance with the inputted control signal (Step S1$2).

The exposure head controlling section 68 outputs the control signals, which are specific to the individual positions occupied by the exposure heads 30 relative to the substrate 12, to the exposure heads 30 sequentially as the movable stage 14 is moved.

The substrate 12 is exposed to light based on the control signals sequentially outputted to the exposure heads 30 as the movable stage 14 is moved, and the exposure is ended when the cameras 26 detect the rear edge of the substrate 12.

When the entire surface of the substrate 12 is exposed to light by the exposure heads 30 of the exposure scanner 24, the stage 14 is moved upstream to the initial position where the stage 14 is stopped so as to unload the substrate 12 exposed to light from the stage 14 (Step S154).

The exposure system 10 will repeat the exposure processing, from Step S140 to Step S154, if there is another substrate 12 to be exposed to light, and end the exposure processing if there is no substrate 12 any more to be exposed to light.

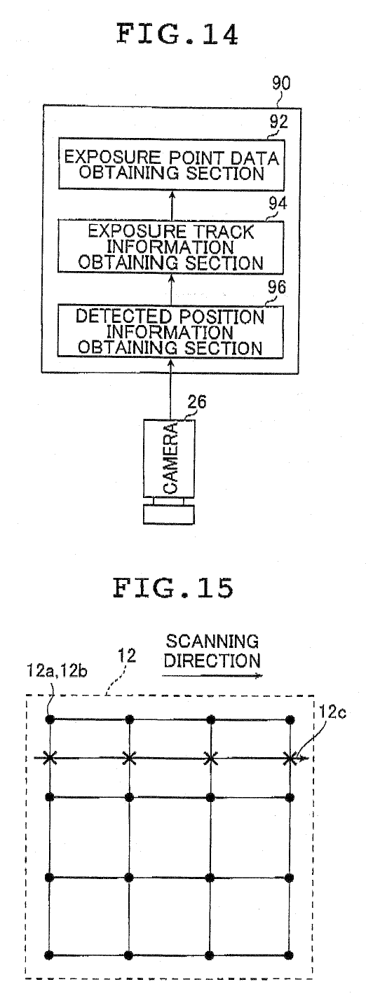

The above-mentioned embodiments use the image transformation processing device 70 shown in FIG. 6 for the rotation and scaling sections 56 and 62 of the drawing point data obtaining apparatus 11 in the exposure system 10. Alternatively, an exposure point data obtaining device 90 shown in FIG. 14 may be employed as mentioned above.

The exposure point data obtaining device 90 shown in FIG. 14 is an example of the drawing point data obtaining device that uses drawing point data tracking called a beam tracing method and is proposed by the inventor of the present invention in Japanese Patent Application No. 2005-103788 (JP 2006-309200 A) filed by the applicant of the present invention.

FIG. 14 is a block diagram of an embodiment of the exposure point data obtaining device applied to the drawing point data obtaining apparatus that carries out the drawing point data obtaining method of the present invention.

The exposure point data obtaining device 90 of FIG. 14 is a device applied to the rotation and scaling sections 56 and 62, preferably, the rotation and scaling section 62, and has a detected position information obtaining section 96, an exposure track information obtaining section 94, and an exposure point data obtaining section 92. The detected position information obtaining section 96 obtains detected position information on the reference marks 12a from images of the reference marks 12a picked up by the cameras 26. The exposure track information obtaining section 94 obtains, based on the detected position information obtained by the detected position information obtaining section 96, information about the exposure tracks of the individual micromirrors 38 of the DMDs 36 in the exposure heads 30, which are made in an image space on the substrate 12 during actual exposure to light. The exposure point data obtaining section 92 obtains exposure point data (drawing point data) for every micromirror 38 based on the exposure track information obtained by the exposure track information obtaining section 94 for every micromirror 38, and on input image data (raster data). The input image data is the raster data (original image data) outputted from the vector-raster conversion section 54 when the device 90 is applied to the rotation and scaling section 56 of the data input unit 42 in the exposure system 10 of FIG. 5, while it is the temporary transformed image data chosen by the image selecting section 60 and outputted from the memory section 58 when the device 90 is applied to the rotation and scaling section 62 of the exposure data creating unit 46.

The detected position information obtaining section 96, which obtains detected position information on the reference marks 12a from the cameras 26, may be omitted from the exposure point data obtaining device 90 applied to the rotation and scaling section 62, if the substrate transformation calculating section 66 of the substrate transformation measuring unit 44 shown in FIG. 5 doubles as the detected position information obtaining section 96 and the detected position information on the reference marks 12a is inputted to the rotation and scaling section 62 through the image selecting section 60 of the exposure data creating unit 46.

The operation of the exposure point data obtaining device 90 will be described next.

Described below is a case of employing the exposure point data obtaining device 90 for the rotation and scaling section 62, but the exposure point data obtaining device 90 is also applicable to the rotation and scaling section 56 as mentioned above .

The exposure point data obtaining device 90 does not obtain exposure point data by itself, but by obtaining, through the exposure system 10, exposure tracks of the individual micromirrors 38 of the DMDs 36 in the exposure heads 30. The following description therefore includes the operation of the exposure system 10 shown in FIGS. 1 and 5.

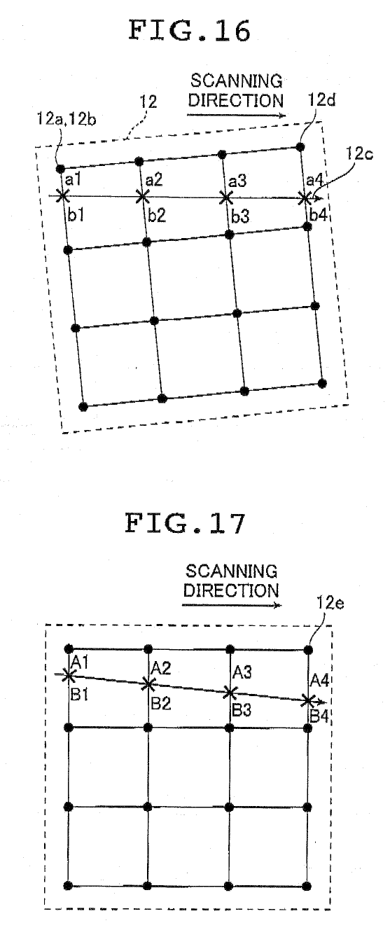

For the sake of simplification, it is assumed in the following description that the transformation of the substrate 12 is only by rotation as shown in FIGS. 16 and 17 which will be described later. The beam tracking method performed with the exposure point data obtaining device 90, however, is more effective for scaling, namely enlargement or reduction, arbitrary deformation such as distortion, deviation of the movable stage 14 in a direction orthogonal to the stage moving direction, speed fluctuations of the moving substrate 12, meandering and yawing of the substrate 12, and the like.

First, temporary transformed image data chosen by the image selecting section 60 of the exposure data creating unit 46 in the exposure system 10 of FIG. 5 is outputted from the memory section 58 to the exposure point data obtaining section 92 of the exposure point data obtaining device 90 shown in FIG. 14, and briefly stored in the exposure point data obtaining section 92 as input image data.

Meanwhile, in the exposure system 10 of FIG. 1, the controller 52, which controls the operation of the entire exposure system 10, outputs a control signal to the moving mechanism 50. In response to the control signal, the moving mechanism 50 moves the movable stage 14 along the guides 20 upstream from the position shown in FIG. 1 to a specified initial positions and then moves the stage 14 downstream at a desired speed.

The substrate 12 on the movable stage 14 moved in a manner described above passes under the multiple cameras 26, whereupon images of the substrate 12 are picked up by the cameras 26, and picked-up image data representing the picked-up images is inputted to the detected position information obtaining section 96. The detected position information obtaining section 96 obtains, from the entered picked-up image data, the detected position information which indicates the positions of the reference marks 12a in the substrate 12. In this embodiment, the cameras 26 and the detected position information obtaining section 96 constitute a position information detecting unit.

The detected position information on the reference marks 12a obtained in this manner is outputted from the detected position information obtaining section 96 to the exposure track information obtaining section 94.

The exposure track information obtaining section 94 obtains, from the, entered detected position information, information about the exposure tracks of the respective micromirrors 38 which are made in the image space on the substrate 12 during actual exposure to light. To be more specific: Passing point information indicating the points at which the images of the individual micromirrors 38 of the DMDs 36 in the individual exposure heads 30 pass is set in advance in the exposure track information obtaining section 94 for each micromirror 38. The passing point information is set in advance based on the positions in which the exposure beads 30 are mounted relative to the substrate 12 on the movable stage 14, and is expressed as a vector, or coordinate values of multiple points, using the same origin as used for the reference mark position information as described before and the above detected position information. FIG. 15 schematically shows the substrate 12 that has not undergone pressing or other similar processes and therefore retains an ideal shape, specifically, the substrate 12 that is not distorted, scaled, or otherwise transformed, that is not rotated and that has the reference marks 12a located in the predetermined positions which are indicated by the reference mark position information 12b, and the passing point information 12c on a given micromirror 38 such that the relationship of the substrate 12 and the information 12c is clearly seen.

The exposure track information obtaining section 94 finds the coordinate values of the intersection points at which the straight line representing the passing point information 12c on a micromirror 38 intersects with the straight lines each connecting the pieces of detected position information 12d that are adjacent to each other in a direction primarily orthogonal to the scanning direction as shown in FIG. 16. The intersection points are marked with crosses in FIG. 16. Moreover, the distances from a point with a cross to the pieces of detected position information 12d which are each adjacent to the point in the above primarily orthogonal direction are found, and the ratio of one distance to the other is determined. In the example as shown in FIG. 16, ratios a1:b1, a2:b2, a3:b3, and a4:b4 are obtained as the exposure track information. The thus obtained ratios represent the exposure track of the micromirror 38 to be made on the substrate 12 after transformation by rotation. If the pieces of reference mark position information 12b are considered to indicate the position of the pattern on a lower layer, the obtained exposure track represents the exposure track of a beam that is made in the image space on the substrate 12 during actual exposure to light. When the passing point information 12c is located outside the range defined by the pieces of detected position information 12d, the external ratio of a piece of detected position information 12d to a point with a cross is determined.

When the device 90 is applied to the rotation and scaling section 62, the exposure track information obtaining section 94 does not use the detected position information on the reference marks 12a, which is obtained from the data representing the image picked up by the cameras 26, as it is. The exposure track information obtaining section 94 needs to use a differential obtained by removing the transformation amount such as rotation angle (and scaling factor) of the temporary transformed image data that is the input image data, namely differential processing condition, to obtain the detected position information 12d on the reference marks 12a. The transformation of the substrate 12, which is found out of the detected position information 12d on the reference marks 12a obtained in such a manner, is shown in FIG. 16.

The exposure track information obtained for each micromirror 38 in a manner described above is inputted to the exposure point data obtaining section 92.

As mentioned above, the input image data which is raster data is briefly stored in the exposure point data obtaining section 92. Based on the entered exposure track information, the exposure point data obtaining section 92 obtains exposure point data for each micromirror 38 from the input image data.

To be more specific: The input image data stored in the exposure point data obtaining section 92 has the input image data reference position information 12e attached thereto, which is allocated to the position corresponding to that indicated by the reference mark position information 12d as shown in FIG. 17. The straight lines, each of which connects the pieces of input image data reference position information 12e adjacent with each other in a direction orthogonal to the scanning direction, are divided at the ratios indicated by the exposure track information, and the coordinate values of the points at which the straight lines are divided, respectively, are determined. In other words, the coordinate values of the points that satisfy the expressions given below are obtained. Although not shown in FIG. 17, pixels in the image data of FIG. 17 indicate a wiring pattern to be formed by exposure.
a1:b1=A1:B1
a2:b2=A2:B2
a3:b3=A3:B3
a4:b4=A4:B4

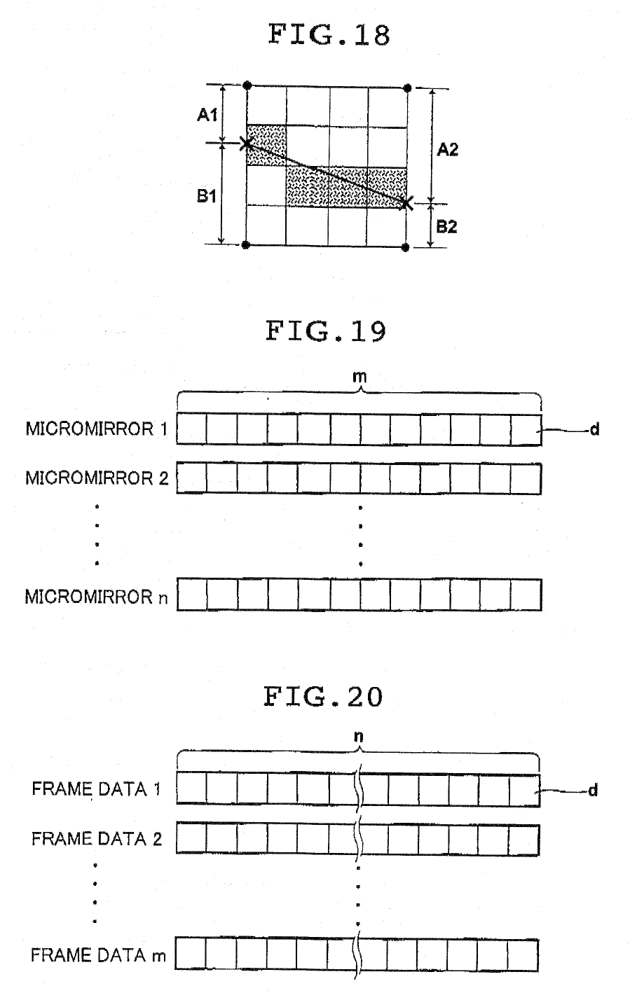

Pixel data d on a straight line that connects the points obtained in a manner described above (data reading track or data track) is exposure point data that actually corresponds to the exposure track information of the micromirror 38. The pixel data d at a point in the input image data, through which point the straight line runs, is therefore obtained as exposure point data. In this regard, a piece of pixel data d refers to the minimum unit data as a constituent of input image data. An enlarged view of an upper left part of FIG. 17 is shown in FIG. 18. The pieces of pixel data in hatched portions in FIG. 19 are obtained as exposure point image data. When the straight line connecting the points at which the above division of lines is carried out at the ratios indicated by the exposure track information is not in the input image data, the exposure point data on the straight line is obtained as null.

Exposure point data obtained may be pixel data on a straight line connecting the points at which the above division of lines is carried out at the ratios indicated by the exposure track information as in the above, or may be pixel data on a curve that connects the dividing points through spline interpolation or the like. When the dividing points are connected by a curve through spline interpolation or the like, the resultant exposure point data is truer to the transformation of the substrate 12. If the properties (e.g., property of expanding/contracting only in a particular direction) of the material for the substrate 12 are reflected on a calculation method for spline interpolation or the like, the resultant exposure point data is even truer to the transformation of the substrate 12.

For each micromirror 38, pieces of exposure point data are obtained in a manner described above. The exposure point data obtaining device 90 thus obtains for multiple micromirrors 38 of the DMD 36 in each exposure head 30 as much exposure point data as necessary to expose the substrate 12 to light. With the exposure point data obtaining device 90, the rotation and scaling section 62 can obtain exposure point data (mirror data) more quickly.

The drawing point (exposure point) data (e.g., mirror data) obtained in the rotation and scaling section 62 is outputted from the rotation and scaling section 62 to the frame data creating section 64, where matrix transposition conversion, for example, is performed as will be described later to convert the drawing point data into frame data which is an aggregation of the pieces of exposure data given to the individual micromirrors 38 of the DMDs 36 in the exposure heads 30 upon exposure.

The frame data thus created by the frame data creating section 64 is outputted to the exposure head controlling section 68 of the exposure unit 48 as described above, and the substrate 12 is exposed to light by the exposure heads 30.

As mentioned above, the exposure head controlling section 68 outputs the control signals, which are specific to the individual positions occupied by the exposure heads 30 relative to the substrate 12, to the exposure heads 30 sequentially as the movable stage 14 is moved. With the control signals being outputted, the pieces of exposure point data corresponding to the individual positions of the exposure heads 30 may be read out one by one front each of the data strings which each contain m pieces of exposure point data obtained for one micromirror 38 as shown in FIG. 19 for instance, and outputted to the DMDs 36 in the exposure heads 30. Alternatively, the exposure point data obtained as shown in FIG. 19 may be subjected to a rotation by 90°, transpositional conversion using a matrix, or other processing to create frame data 1 through frame data m as shown in FIG. 20, which correspond to the individual positions occupied by the exposure heads 30 relative to the substrate 12, and output the frame data 1 through m sequentially to the exposure heads 30.

When the exposure point data obtaining device 90 is applied to the rotation and scaling section 56 as mentioned before, the exposure track information obtaining section 94 needs to use a transformation amount such as rotation angle and scaling factor, which constitutes a processing condition for input image data, for the detected position information on the reference marks 12a that is obtained from the data representing the image picked up by the cameras 26 so as to obtain the detected position information 12d on the reference marks 12a.

In the example described above, exposure point data is obtained in the exposure point data obtaining device 90 by using a transformation amount such as rotation angle and scaling factor, which constitutes a processing condition for input image data, or a transformation amount such as rotation angle differential and scaling factor differential, which constitutes a differential processing condition. The exposure point data obtaining device 90, however, is also applicable to the cases where arbitrary transformation or the like is to be performed.

In the exposure system 10 that employs the exposure point data obtaining device 90 for the rotation and scaling sections 56 and 62, multiple reference marks 12a provided in advance in specified positions on the substrate 12 are detected to obtain the detected position information which indicates the positions of the reference marks 12a, exposure track information is obtained for each micromirror 38 based on the detected position information obtained, and pixel data d corresponding to the exposure track information obtained for each micromirror 38 is obtained from exposure image data D as exposure point data. This makes it possible to obtain exposure point data that reflects the transformation of the substrate 12, and an exposure image adapted to the transformation of the substrate 12 is formed on the substrate 12 by exposure. Therefore, patterns on layers of a multilayer printed wiring board or the like are so formed as to accommodate transformations that the respective layers may receive during exposure, and the patterns on the different layers can be aligned with one another.

The above description addresses an exposure point data obtaining method for light exposure of the substrate 12 that has been transformed by pressing or other similar processes. A similar method can be employed to obtain exposure point data in exposing the substrate 12 to light that has not been transformed and has an ideal shape. For instance, information on exposure point data track in exposure image data, which corresponds to the passing point information set in advance for each micromirror 38, may be obtained and, based on the obtained exposure point data track information, multiple pieces of exposure point data corresponding to the exposure point data track may be obtained from the exposure image data.

Such a method as above, in which exposure point data track information is set in advance in exposure image data based on the passing point information set for each micromirror 38, and exposure point data is obtained based on the exposure point data track which is represented by the exposure point data track information, is also applicable when an exposure image is formed by exposure for the first time on the substrate having no exposure image formed thereon. The method can also be employed when exposure image data is so transformed as to match the transformation of the substrate 12. Employing this method makes it possible to calculate addresses of the memory, in which the exposure image data is stored, along the exposure point data track so as to obtain exposure point data, and thus facilitates the calculation of addresses.

In the case where the substrate 12 has expanded or contracted in the scanning direction, the number of pieces of exposure point data obtained from one piece of pixel data d in input image data may be changed in accordance with the degree of expansion or contraction. Not only when the substrate 12 has expanded or contracted solely in the scanning direction but when it has further been transformed in other directions, if the length of the passing point information of the micromirrors 38 varies from one area of the substrate 12 partitioned with the detected position information 12d to another, the number of pieces of exposure point data obtained from one piece of pixel data may be changed in accordance with the length of the passing point information. Changing the number of pieces of exposure point data depending on the degree of expansion or contraction of the substrate 12 makes it possible to form by exposure a desired exposure image in a desired position on the substrate 12.

If a deviation of the movable stage 14 in a direction orthogonal to the stage moving direction is to be compensated, or a deviation of the substrate 12 is to be compensated in addition to its rotation and scaling, in exposing the substrate 12 to light as mentioned above, the exposure point data obtaining device 90 is provided with a deviation information obtaining section in place of, or in addition to, the detected position information obtaining section 96. Based on the deviation information obtained by the deviation information obtaining section, the exposure track information obtaining section 94 obtains information on the exposure tracks of the individual micromirrors 38 that are made on the substrate 12 during actual exposure to light.

If moving speed fluctuations of the substrate 12 is to be compensated in addition to its rotation and scaling in exposing the substrate 12 to light as mentioned above, the exposure point data obtaining device 90 is provided with a speed fluctuation information obtaining section, which obtains speed fluctuation information of the moving substrate 12, in addition to the detected position information obtaining section 96. Based on the speed fluctuation information obtained by the speed fluctuation information obtaining section, the exposure track information obtaining section 94 obtains information on the exposure tracks of the micromirrors 38 that are made on the substrate 12 during actual exposure to light.

When equipped with the deviation information obtaining section which obtains deviation information of the substrate 12 and the speed fluctuation information obtaining section which obtains speed fluctuation information of the moving substrate 12, the exposure point data obtaining device 90 is capable of not only compensation of the meandering of the movable stage 14 but also compensation taking the yawing into account, in other words, taking the attitude upon moving of the substrate 12 into account.

The exposure system described in the above-mentioned embodiments has a DMD as a spatial light modulator. Apart from such reflection-type spatial light modulators, transmission-type ones may also be employed.

In the above-mentioned embodiments, a flatbed-type exposure system is described as an example. Instead of this type, an outer drum-type (or inner drum-type) exposure system having a drum on which a photosensitive material is wound may be employed.

The substrate 12 which is the object to be exposed to light in the above-mentioned embodiments may be the substrate of a flat panel display instead of that of a printed wiring board. In that case, the pattern formed may be one used for liquid crystal displays and so forth, which makes a color filter, a black matrix, or a semiconductor circuit such as a TFT. The substrate 12 may have a sheet-like shape or an elongated shape (e.g., a flexible substrate).

The drawing method and apparatus of the above embodiments can also be applied to the drawing in an inkjet printer or other similar printers. For instance, drawing points can be formed through the ejection of ink in a manner similar to the present invention. In other words, the drawing point forming areas of the present invention can be considered as the areas to which the ink droplets ejected from the individual nozzles of an inkjet printer are adhered.

In the embodiments as above, the drawing track information may represent the drawing tracks of drawing point forming areas made on an actual substrate, or the drawing tracks of drawing point forming areas approximate to those made on an actual substrate, or the drawing tracks of drawing point forming areas predicted as those made on an actual substrate.

In the embodiments as above, the number of pieces of drawing point data, which are obtained from individual pieces of pixel data constituting image data, may be changed in accordance with the length of a drawing track that is indicated by the drawing track information such that the number of pieces of drawing point data is increased as the length is increased, while decreased as the length is decreased.

The image space in the embodiments as above may be a coordinate space which is defined on the basis of the image to be formed, or already formed, on a substrate.

The drawing track information of drawing point forming areas in the embodiments as above can thus be obtained both in terms of a drawing track in a substrate coordinate space and in terms of a drawing track in an image coordinate space. The substrate coordinates and the image coordinates differ from each other in some cases.

The above-mentioned embodiments may be modified such that one exposure point data track is obtained for every two or more micromirrors (beams). For instance, an exposure point data track may be obtained for each group of beams that are condensed by one and the same microlens out of the microlenses constituting a microlens array.

Data reading pitch information may be attached to each piece of exposure point data track information. In that case, the pitch information may contain a sampling rate (ratio of the minimum distance a beam travels upon switching of drawing point data (common to all the beams if there is no compensation to be made) to the image resolution (pixel pitch)). The pitch information may also contain information about the increase or decrease of pieces of exposure point data involved in the length compensation of an exposure track. In addition to the exposure point data increase/decrease information, the pitch information may be caused to contain the locations at which the increase or decrease takes place, and then attached to the exposure track information. Moreover, the individual pieces of exposure point data track information may be caused to have all the data reading addresses (x, y) (time-series reading addresses) corresponding to the individual frames.

The direction along a data reading track in image data may be matched with the direction in which addresses are continuous in the memory. For instance, when image data is stored in the memory such that addresses are continuous in -he horizontal direction as in the example of FIG. 17, reading of image data for each beam can be carried out quickly. The memory employed can be a DRAM, although any other kind of memory is thinkable as long as stored data can be read quickly and sequentially in a direction in which addresses are continuous. For example, a static random access memory (SRAM) and other random access memories that are faster in operation among PAMs can be employed. In that case, the direction in which addresses are continuous in the memory may be defined as the direction along an exposure track, and data may be read along the direction in which the addresses are continuous. The memory may be wired or programmed in advance such that data is read along a direction in which addresses are continuous. The direction in which addresses are continuous may be the direction along a path through which continuous multiple bits of data are read at a time,

What is claimed is:

1. A drawing point data obtaining method of subjecting original image data to transformation processing to obtain transformed image data as drawing point data which is used to draw an image carried by said original image data on a drawing target, comprising the steps of:
maintaining in ad-vance multiple sets of transformed image data obtained by performing said transformation processing on said original image data through a first processing method under multiple different transformation processing conditions, respectively;
choosing, as temporary transformed image data, one set out of said multiple sets of transformed image data which has been obtained under a transformation processing condition close to an entered transformation processing condition in said multiple different transformation processing conditions and
performing said transformation processing on the thus chosen temporary transformed image data through a second processing method in accordance with a differential between said entered transformation processing condition and said transformation processing condition for said chosen temporary transformed image data to thereby obtain said transformed image data as said drawing point data.

2. The drawing point data obtaining method according to claim 1, wherein, when said chosen temporary transformed image data is input image data and said differential is a transformation processing condition of said transformation processing, said second processing method comprises the steps of:
setting post-transformation vector information which connects pixel position information indicating arranging positions where pixel data of said transformed image data to be obtained is located;
obtaining part of said pixel position information on a post-transformation vector represented by the thus set post-transformation vector information;
subjecting only the thus obtained part of said pixel position information to an inverse conversion calculation being inverse transformation processing opposite to said transformation processing to obtain inversely-converted pixel position information on said input image data that corresponds to said part of said pixel position information;
obtaining, based on said inversely-converted pixel position information thus obtained, input pixel data corresponding to said post-transformation vector from said input image data; and
obtaining said input pixel data as pixel data in a position indicated by said pixel position information on said post-transformation vector, to thereby obtain said transformed image data.

3. The drawing point data obtaining method according to claim 2,
wherein said step of obtaining said input pixel data comprises the steps of:
setting input vector information on said input image data which connects said inversely-converted pixel position information; and
obtaining, from said input image data, said input pixel data on an input vector represented by the thus set input vector information, and
wherein said input pixel data is obtained as said pixel data in the position indicated by said pixel position information on said post-transformation vector and thereby, said transformed image data is obtained.

4. The drawing point data obtaining method according to claim 3, wherein said input vector information is set by connecting said inversely-converted pixel position information by a curve.

5. The drawing point data obtaining method according to claim 3, wherein said input vector information contains a pitch component for obtaining said input pixel data, or said pitch component for obtaining said input pixel data is set based on said input vector information.

6. The drawing point data obtaining method according to claim 2, wherein, when said original image data is said input image data and a transformation processing condition of said transformation processing is one of said multiple different transformation processing conditions, said first processing method comprises the same steps as said second processing method.

7. The drawing point data obtaining method according to claim 2, wherein, in order to draw said image using a two-dimensional spatial modulator having multiple drawing point forming areas which are arrayed two-dimensionally, said drawing point data is mapped onto said multiple drawing point forming areas of said two-dimensional spatial modulator and created as frame data composed of an aggregation of drawing data which is used for drawing on said multiple drawing point forming areas.

8. The drawing point data obtaining method according to claim 1, wherein, when said chosen temporary transformed image data is input image data, said differential is a transformation processing condition of said transformation processing, and said drawing target has undergone a transformation whose amount is equal to said differential, said second processing method comprises the steps of:
moving relatively in relation to said drawing target drawing point forming areas in which drawing points are formed based on the drawing point data; as well as
forming said drawing points on said drawing target sequentially in response to movement of said drawing target and drawing point forming areas to obtain said drawing point data used for drawing an image carried by said input image data on said drawing target, and
said second processing method further comprises the steps of:
obtaining information about drawing point data tracks of said drawing point forming areas of said image on said input image data; and
obtaining multiple pieces of said drawing point data that correspond to said drawing point data tracks from said input image data based on the thus obtained information about said drawing point data tracks.

9. The drawing point data obtaining method according to claim 8, wherein said step of obtaining said information about said drawing point data tracks comprises the steps of:
obtaining information about drawing tracks of said drawing point forming areas on said drawing target when said image carried by said input image data is formed; and
obtaining said information about said drawing point data tracks of said drawing point forming areas of said image on said input image data based on the thus obtained information about said drawing tracks.

10. The drawing point data obtaining method according to claim 8, wherein said step of obtaining said information about said drawing point data tracks comprises the steps of:
obtaining information about drawing tracks of said drawing point forming areas in an image space on said drawing target; and
obtaining said information about said drawing point data tracks of said drawing point forming areas of said image on said input image data based on the thus obtained information about said drawing tracks.

11. The drawing point data obtaining method according to claim 8, wherein, when said original image data is said input image data and a transformation amount in said transformation of said drawing target is one of multiple different transformation amounts in said transformation of said drawing target, said first processing method comprises the same steps as said second processing method of the drawing point data obtaining method according to claim 2

12. The drawing point data obtaining method according to claim 8, wherein, when said original image data is said input image data and a transformation amount in said transformation of said drawing target is one of multiple different transformation amounts in said transformation of said drawing target, said first processing method comprises the same steps as said second processing method.

13. The drawing point data obtaining method according to claim 8, wherein, in order to draw said image using a two-dimensional spatial modulator having multiple drawing point forming areas which are arrayed two-dimensionally,
said drawing point data is obtained for each of said multiple drawing point forming areas of said two-dimensional spatial modulator, the thus obtained multiple pieces of said drawing point data are arrayed two-dimensionally in accordance with said multiple drawing point forming areas, and
said multiple pieces of said drawing point data thus arrayed two-dimensionally are transposed and created as frame data composed of an aggregation of drawing data which is used for drawing with multiple drawing elements of said two-dimensional spatial modulator.

14. The drawing point data obtaining method according to claim 1, wherein said original image data and said transformed image data are compressed image data.

15. The drawing point data obtaining method according to claim 1, wherein said original image data and said transformed image data are binary image data.

16. A drawing method comprising the step of: drawing an image carried by original image data on a drawing target based on drawing point data that is obtained by the drawing point data obtaining method according to claim 1.

17. A drawing point data obtaining apparatus for subjecting original image data to transformation processing to obtain transformed image data as drawing point data which is used to draw an image carried by said original image data on a drawing target, comprising:
a data maintaining section for maintaining in advance multiple sets of transformed image data obtained by performing said transformation processing on said original image data through a first processing method under multiple different transformation processing conditions, respectively;
an image selecting section for choosing, as temporary transformed image data, one set out of said multiple sets of transformed image data which has been obtained under a transformation processing condition close to an entered transformation processing condition in said multiple different transformation processing conditions; and
a transformation processing section for performing said transformation processing on the thus chosen temporary transformed image data through a second processing method in accordance with a differential between said entered transformation processing condition and said transformation processing condition for said chosen temporary transformed image data to thereby obtain said transformed image data as said drawing point data.

18. The drawing point data obtaining apparatus according to claim 17, wherein, when said chosen temporary transformed image data is input image data and said differential is a transformation processing condition of said transformation processing, said transformation processing section executes said second processing method and comprises:
a post-transformation vector information setting section for setting post-transformation vector information which connects pixel position information indicating arranging positions where pixel data of said transformed image data to be obtained is located;
a pixel position information obtaining section for obtaining part of said pixel position information on a post-transformation vector represented by said post-transformation vector information set by said post-transformation vector setting section;
an inverse conversion calculating section for subjecting only said part of said pixel position information obtained by said pixel position information obtaining section to an inverse conversion calculation being inverse transformation processing opposite to said transformation processing to obtain inversely-converted pixel position information in said input image data that corresponds to said part of said pixel position information;
an input pixel data obtaining section for obtaining, based on said inversely-converted pixel position information obtained by said inverse conversion calculating section, input pixel data corresponding to said post-transformation vector from said input image data; and
a transformed image data obtaining section for obtaining said input pixel data obtained by said input pixel data obtaining section as pixel data in a position indicated by said pixel position information on said post-transformation vector, to thereby obtain said transformed image data.

19. The drawing point data obtaining apparatus according to claim 17, further comprising: a frame data creating section, in order to draw said image using a two-dimensional spatial modulator having multiple drawing point forming areas which are arrayed two-dimensionally, for mapping said drawing point data onto said multiple drawing point forming areas of said two-dimensional spatial modulator and creating the thus mapped drawing point data as frame data composed of an aggregation of drawing data which is used for drawing on said multiple drawing point forming areas.

20. The drawing point data obtaining apparatus according to claim 17, wherein, when said chosen temporary transformed image data is input image data, said differential is a transformation processing condition of said transformation processing, and said drawing target has undergone a transformation whose amount is equal to said differential, said transformation processing section executes said second processing method, moves relatively in relation to said drawing target drawing point forming areas in which drawing points are formed based on the drawing point data as well as forms said drawing points on said drawing target sequentially in response to movement of said drawing target and drawing point forming areas to obtain said drawing point data used for drawing an image carried by said input image data on said drawing target, and comprises:
a drawing point data track information obtaining section for obtaining information about drawing point data tracks of said drawing point forming areas of said image on said input image data; and
a drawing point data obtaining section for obtaining multiple pieces of said drawing point data that correspond to said drawing point data tracks from said input image data based on said obtained information about said drawing point data tracks.

21. The drawing point data obtaining apparatus according to claim 20, further comprising; a frame data creating section, in order to draw said image using a two-dimensional spatial modulator having multiple drawing point forming areas which are arrayed two-dimensionally, for obtaining said drawing point data for each of said multiple drawing point forming areas of said two-dimensional spatial modulator, for arraying the thus obtained multiple pieces of said drawing point data two-dimensionally in accordance with said multiple drawing point forming areas, and transposing said multiple pieces of said drawing point data thus arrayed two-dimensionally to create as frame data composed of an aggregation of drawing data which is used for drawing with multiple drawing elements of said two-dimensional spatial modulator.

22. A drawing apparatus comprising:
a drawing point data obtaining apparatus according to claim 17; and
a drawing unit for drawing an image carried by said original image data on said drawing target based on said drawing point data obtained by said drawing point data obtaining apparatus.
